(19) United States
(12) Patent Application Publication
(10) Pub. No.: US 2001/0052887 A1
(43) Pub. Date: Dec. 20, 2001

(54) Method and circuit for driving display device

(76) Inventors: Yusuke Tsutsui, Hashima-shi (JP); Makoto Kitagawa, Anpachi-gun (JP); Mitsugu Kobayashi, Nagoya-shi (JP); Hisao Uehara, Ogaki-shi (JP); Makoto Fujioka, Ogaki-shi (JP)

Correspondence Address: HOGAN & HARTSON L.L.P., 500 S. GRAND AVENUE, SUITE 1900, LOS ANGELES, CA, 90071-2611, US

(21) Appl. No.: 09/832,167

(22) Filed: Apr. 9, 2001

(30) Foreign Application Priority Data
Apr. 11, 2000 (JP) 2000-109958
Mar. 29, 2001 (JP) 2001-96386
Mar. 29, 2001 (JP) 2001-96471
Mar. 29, 2001 (JP) 2001-96576

(51) Int. Cl. G09G 3/36

(52) U.S. Cl. 345/87

(57) ABSTRACT

In the driving of a liquid crystal display panel with pixels in a matrix comprising n rows and m columns, when a partial display instruction is issued, respective rows in a display area (202) of s rows and m columns within the matrix are sequentially selected for one frame. Then, predetermined partial display data is written into the selected rows. Predetermined background data such as white display data is written into the background area (204) other than the partial display area (202). In the background area 204, either k rows and m columns or pixels of (the leading row ((s+1)-th row) of the background area, next to the final row in the partial display area) are selected during one frame for writing of the background display data, k rows and m columns are sequentially shifted each frame.

### BACKGROUND OF THE INVENTION

1. Field of the Invention

The present invention relates to a method and circuit for driving a flat display device such as a liquid crystal display. The present invention also relates to a technique of generating a partial display on such a flat display device.

2. Description of Related Art

Flat display devices, typified by liquid crystal displays, organic electroluminescence displays, and equivalents, are thin and lightweight and have low power consumption. These devices are preferable for portable devices such as mobile telephones, and have come to be used in a large number of portable devices.

A matrix-type display device which can display an arbitrary pattern generated by a plurality of pixels arranged in a matrix form; a segment-type display device such as commonly used in timepieces, which can display a fixed pattern; and a hybrid display device comprising a combination of matrix and segment elements are known types of flat display devices.

To meet the demand for reduction in power consumption of equipment including display devices, there is a great demand to reduce the power consumption of the display devices themselves. Conventional display devices that partially display only a minimum area of a screen in a power saving mode are well known. To enable partial display, a liquid crystal display device may have, for example, both a fixed pattern display area and another display area. The fixed pattern display area may be formed on a portion of the display area to indicate, for example, an amount of battery power or time remaining. On the other area, a number of pixels may be arranged in a matrix form to display an arbitrary pattern. With such a configuration, partial display in a power saving mode can be realized by driving only the fixed pattern display area to display just a fixed pattern.

With such a configuration, with plural areas that can be driven independently and controllably disposed on the same display panel, just a desired area can be displayed on demand. However, there has been a desire for screens to have the capability of displaying a desired pattern or information at a desired position even in the power saving mode. Current display panels that with predivided display areas cannot meet this demand.

Moreover, desired display content and display position in a power saving mode vary according to the type of equipment on which the display is installed. Currently, each display panel configuration and driver must be individually developed for the demands of each specific application.

While today's matrix-type display panels can be driven to display desired information at a desired position, in such displays, even when a pattern is only partially displayed in a partial display mode, all other areas must be driven normally. As a result, power consumption cannot be effectively decreased in the partial display mode.

### SUMMARY OF THE INVENTION

This invention is made to overcome the above-described problems. It is an object of the present invention to provide a display device that can partially display a pattern at an arbitrary position and can reduce, as necessary, the power consumption in the partial display mode.

Another object of the present invention is to provide a display device that can partially display a pattern at an arbitrary position and can improve the display quality in a remaining background area.

A further another object of the present invention is to provide a display device that can smoothly switch the screen in the transition in which the mode changes from normal display to partial display.

The present invention achieves the above objects using the features as described below.

The present invention relates to a method of driving a display device. The display device has a plurality of pixels in a matrix of n rows and m columns. The display device performs a desired partial display on a partial display area in accordance with a partial display instruction. The partial display area is formed of pixels of an area of s rows by m columns, where s is a desired value. The display device displays a background on the remaining background area of the matrix of n rows and m columns. In this driving method, wherein during one frame in a partial display mode, partial display data is written into each pixel of the s row by m column partial display area, and background display data is written into pixels of an area of k rows by m columns in the background area. Each of n, m, s, and k is an integer more than 1 and s <n and k<n.

In another aspect of the present invention, selected rows associated with pixels of the (k row×m columns) in the background area are shifted every one frame.

Another aspect of the present invention, the background display data is written into each pixel in the background area over a total ((n−s)/k) frame duration.

Another aspect of the present invention, the background display data is written into each pixel in the background area over a total ((n−s)/k) frame duration. The polarities of the background display data are inverted with respect to a reference potential, the inverted background display data is written into pixels in the same row in a next total ((n−s)/k) frame duration.

In another aspect of the present invention, rows other than k rows selected during one frame in the background display area are inhibited from being selected.

The present invention also relates to a drive circuit suitable for a display device, said display device having a plurality of pixels in a matrix comprising n rows and m columns, and said plurality of pixels are selected every row line and display display data supplied from a column line, when a partial display instruction is issued, during one frame, said display device selects pixels in an area of s rows by m columns in said matrix comprising n rows and m columns, sequentially writes predetermined partial display data, selects pixels in an area of k rows by m columns in a remaining background area in said matrix comprising n rows and m columns, and writes background display data, said drive circuit comprising: a row clock generator for generating a row clock corresponding to a row selection duration of each row;a row clock counter for counting a row clock every one frame; a partial display row detector for detecting an incoming timing for s rows to which said partial display data is written; a background display row detector for detecting an incoming timing for a k row to which background display data is written during said one frame; and a driver control signal generator for producing a driver control signal when said partial display row detector or said background display row detector detects an arrival of a row to be displayed, said driver control signal allowing a row driver driving said matrix comprising n row and m columns every row to perform a row drive operation; wherein each of n, m, s and k is an integer greater than 1 and s <n and k<n.

In another aspect of the present invention, the drive circuit further comprises a frame counter for counting the number of frames. The background display row detector shifts rows to which said background display data is written based on a count value counted by said frame counter.

In another aspect of the present invention, the display device further comprises a polarity inverted signal generator for inverting a polarity with respect to a predetermined reference voltage of display data every unit duration. Respective pixels in the background display area are respectively selected once over one background display duration being a total (n−s)/k frame duration. The polarity inverted signal generator detects an arrival of the next one background duration and inverting the polarity of the background display data.

Using the driving method and the drive circuit as above, the display device with a display panel such as a liquid crystal panel can realize partial display at desired positions on the panel, without modifying the configuration of the panel itself. In the background area not partially displayed, the power consumption can be reduced, as necessary, by selecting only desired k rows during one frame. In the background area, the background display data is written to areas other than k rows not selected during one frame over a predetermined time of periods. Since the background display data does not normally include special information such as characters, symbols, and the like and changes in information itself, the frequent writing operation is not required. Such background display data leads to less deterioration of display even if the writing period to each pixel is somewhat prolonged. The use of the off-display data as the background display data results in very small deterioration of display contents. Moreover, when the background display data is written every predetermined period, the polarity of display data is inverted. And this inversion is effective to, for example, a liquid crystal display. This can prevent the liquid crystal such as a display element from being deteriorated due to applied dc components.

In another aspect of the present invention, wherein when said partial display instruction is issued, a pixel clock is used as a unit clock, a frequency of said pixel clock being lower than that of a pixel clock used as a unit clock for selecting and normally displaying all pixels of said matrix comprising n rows and m columns during one frame; said partial display data is written into all pixels in said partial display area; and said background display data is written into pixels of said area of k rows by m columns in said background display area.

In another aspect of the present invention, wherein the transfer rate of a row selection pulse is increased, when said partial display instruction is issued, and arrival of a selection duration of rows other than the (k rows×m columns) in the background display area is detected.

In another aspect of the present invention, the drive circuit further comprises a frequency divider for dividing unit clocks used for selecting and normally displaying all pixels of said matrix comprising n rows by m columns; wherein when said partial display instruction is issued, during one frame, using as a unit clock divided pixel clocks from said frequency divider, said partial display data is controlled to write to pixels of said area of s rows by m columns and said background display data is controlled to write to pixels of said area of k rows by m columns.

In another aspect of the present invention, the drive circuit further comprising a row clock controller for detecting, based on a display row detection signal in said partial display row detector and said background row detector, an arrival of a selection duration of rows other than pixels of said area of k rows by m columns, and increasing the frequency of said row clock.

As described above, only certain line in the background area is selected during one frame, and other lines are not selected. The row selection pulse is sequentially transferring and row selection is executed when outputting of the row selection pulse is allowed. The transfer rate of said row selection pulse in row selection increases to all lines (n−s−k) in a non−selection state, by increasing the frequency of the row clock. This enables decreasing the number of rows to be actually selected during one frame in the partial display mode, thus prolonging the selection time per row. As a result, the operational clocks can be reduced by the prolonged time. The power consumption of the display device, particularly of the digital processing circuit can be reduced in the partial display mode.

In another aspect of the present invention, the drive circuit further comprises a mode changeover timing controller for, when an instruction for changing form a normal display mode to a partial display mode is issued, changing display data to all pixels of the n row by m columns matrix to background display data in the next first frame of the instruction and starting the driver control signal generator to generate the driver control signal, from the next frame.

With the above-described control, the background display data is once written to all pixels in the (n row×m columns) matrix after issuance of a partial display instruction to move to the partial display mode. For that reason, written normal data are not gradually lost from pixels not selected for a long period of time in the background area, as with displays applying the present invention.

As described above, according to the present invention, the partial display can be implemented at desired positions, without any change of the configuration of a display panel such as a liquid crystal display panel.

The control may be performed so as to select only some lines in the background area during one frame and to select no other lines to reduce the operational clock. Thus, the power consumption of the display device, particularly of the digital processing circuit can be saved in the partial display mode.

Moreover, according to the present invention, predetermined display data, such as off-display data, are written to all over the background area every predetermined period. Even when data is not written to the background area with the same period as that for the normal display area, deterioration of the display is not noticeable. When being written every predetermined period, the background display data may be inverted so as to alternatively drive the liquid crystal. Thus, the liquid crystal can be prevented from being certainly deteriorated.

When the off-display data is written as the background display data, the data writing period longer than that in the normal display mode is set for the background area. Even in such a case, changes in aging of the background display is negligible so that images can be displayed without substantially decreasing the display quality.

The background display data may be arbitrary color data. The system user can select a favorite background color.

The present invention relates to a method of driving a display device. The display device has a plurality of pixels in a matrix comprising n rows by m columns. The display device performs a partial display on a partial display area in accordance with a partial display instruction. The partial display area is formed of an s rows by m columns matrix, where s is a desired value. The display device displays also a background on the remaining area. In an aspect of the present invention, during one frame in a partial display mode; predetermined partial display data is sequentially written into each pixel of the partial display area; and the background display data is written into pixels of the (s+1)-th row area next to the final row in the partial display area within the background area and into pixels of (k rows×m columns). Each of n, m, s and k is an integer more than 1 and s<n and k<n−s−1.

The present invention also relates to a drive circuit suitable for a display device. The display device has a plurality of pixels in a matrix comprising n rows by m columns, and the plurality of pixels are selected every row line, and display display data supplied from a column line. In another aspect of the present invention, wherein when a partial display instruction is issued, during one frame, said display device selects pixels in an area of s rows by m columns in said matrix comprising n rows and m columns, sequentially writes predetermined partial display data, selects pixels of (s+1)-th row and pixels of an area of k rows by m columns in the remaining background area within said matrix comprising n rows and m columns, and writes background display data, comprising: a row clock generator for generating a row clock corresponding to a row selection duration of each row; a row clock counter for counting a row clock every one frame; a partial display row detector for detecting an incoming timing for s rows to which said partial display data is written; a background display row detector for detecting an incoming timing for the (s+1)-th row and k row to which background display data is written during said one frame; and a driver control signal generator for producing a driver control signal when said partial display row detector or said background display row detector detects an arrival of a row to be displayed, said driver control signal allowing a row driver driving said a matrix comprising n rows and m columns every row to perform a row drive operation, wherein each of n, m, s, and k is an integer more than 1 and s<n and k<n−s−1.

According to the present invention, in the driving method or the drive circuit, selected rows to be selected associated with pixels of the area of k row by m columns in the background area is shifted every one frame.

In another aspect of the present invention, the background display data is written into pixels of (n−s−1) rows by m columns in the background display area over a total ((n−s−1)/k) frame duration.

In another aspect of the present invention, the background display data is written into pixels of (n−s−1) rows by m columns in the background display area over a total ((n−s−1)/k) frame duration; and the polarities of the background display data are inverted with respect to a reference potential inverted background display data into pixels in the same row in a next total ((n−s−1)/k) frame duration.

In another aspect of the present invention, when the partial display instruction is issued, a pixel clock is used as a unit clock and a frequency of which is lower than that of a pixel clock used as a unit clock to select and normally display all pixels of the matrix n rows by m columns during one frame; the partial display data is written into all pixels in the partial display area; and the background display area is written into pixels of the (k rows×m columns) and pixels of the (s+1)-th area, in the background display data.

In another aspect of the driving method or the drive circuit of the present invention, during the next frame after issuance of the partial display instruction, the background display data is written to all pixels of the (n rows×m columns) matrix; or instead of above, predetermined partial display data are sequentially written to respective pixels in the (s rows×m columns) partial display area and the background display data is sequentially written to all pixels of the background area. Then, during each frame after the second frame the partial display data is sequentially written to the pixels in the (s row×m columns) matrix and moreover, the background display data is written to the (s+1)-th pixel and to the pixels in the (k rows x m columns) matrix.

Using the above-described driving method and the drive circuit, the display device with a display panel such as a liquid crystal display can perform a partial display at desired positions on the panel, without changing the configuration of the panel itself. In the background display area not partially displayed, the background display data is written to the leading row of the background display area following the last row of the partial display area every frames, in a manner similar to that to the partial display area. On the other hand, the background display data is written to only the pixels in the (k rows×m columns) matrix of the remaining pixels in the background display area, for one frame duration.

As described above, the leading row in the background area adjacent to the boundary of the partial display area is selected for each frame. Hence, even if the remaining background areas are selected once every several frames, the display content in the partial display area is prevented from being leaked to them, thus from resulting in occurrence of crosstalk. The power consumption can be reduced, as necessary, by selecting a region except the leading row of the background area is selected only the k-th row during one frame. By arranging rows not selected during one frame, the drive time to a selection row can be prolonged by the non−selection time.

Since the background display data does not normally include special information such as characters, symbols, and the like and changes in information itself, the frequent writing operation is not required. Such background display data leads to less deterioration of display even if the writing period to each pixel is somewhat prolonged.

As described above, the present invention can display a partial display at desired positions and can provide a high display quality to the background display in a remaining display area. In the background area, the area selected together with the partial display area during one frame includes the leading row in the background display area and the (k rows×m columns) area being a portion of the remaining area. The number of rows selected during one frame in the partial display mode can be reduced, compared with in the normal display mode. This feature enables low power consumption.

The present invention also relates to a method of driving a display device, wherein said display device having a plurality of pixels in a matrix comprising n rows and m columns, in accordance with a partial display instruction, said display device performing a desired partial display on a partial display area formed of pixels of area of s rows by m columns, where s is a desired value, and said display device displaying a background on a remaining background area of said matrix comprising n rows and m columns; wherein: during a first frame over which said partial display instruction is detected and a normal display mode changes to a partial display mode, predetermined partial display data is sequentially written into each pixel of said partial display area of s rows by m columns; and background display data is sequentially written into pixels of said background area; during each frame after the second frame following the first frame in a partial display mode, said partial display data is written into each pixel of said area of s rows by m columns partial display area; and said background display data is written into pixels of said area of k rows by m columns in said background area; wherein each of n, m, s, and k is an integer more than 1 and s<n and k<n−s.

The present invention also relates to a drive circuit suitable for a display device, wherein said display device having a plurality of pixels in a matrix comprising n rows and m columns, and said plurality of pixels are selected every row line and display display data supplied from a column line, when a partial display instruction is issued, during one frame, said display device selects pixels in an area of s rows by m columns in said matrix comprising n rows and m columns, sequentially writes predetermined partial display data, selects pixels from an area of k rows and m columns in the remaining background area within said matrix comprising n rows and m columns, and writes background display data, comprising: a row clock generator for generating a row clock corresponding to a row selection duration of each row; a row clock counter for counting a row clock every one frame; a partial display row detector for detecting an incoming timing for s rows to which said partial display data is written; a background area detector for detecting an incoming timing for the leading row and the final row of said background area; a background display row detector for detecting an incoming timing for k rows to which background display data is written during one frame in a partial display mode; a data output controller for allowing partial display data to be output for the duration over said partial display row detector detects an arrival of a row to be displayed and for setting output display data to background display data for the duration over which said background area detector detects an arrival of the leading row and the final row in said background area, in the first frame in transition from a normal display mode to a partial display mode; and a driver control signal generator for producing a driver control signal when said partial display row detector or said background display row detector detects an arrival of a row to be displayed after a second frame in transition to a partial display mode, said driver control signal allowing a row driver to perform a row drive operation, wherein each of n, m, s, and k is an integer more than 1 and s<n and k<n−s.

In another aspect of the present invention of the driving method or the drive circuit, the background display data is written into all pixels in the background area over a total (n−s)/k frame duration after the second frame.

In another aspect of the present invention of the driving method or the drive circuit, rows except k rows selected during one frame in the background display area after the second frame are inhibited from being selected.

As described above, the partial display and the background display over the entire background area are implemented in the first frame in transition. In the partial display area, the mode is changed from the normal display directly to the partial display. In the background area, the mode is changed from the normal display directly to the background display. Thus, the frame can be smoothly changed from the normal display to the partial display. After the second frame, this operation can reduce not only the operational clock which selects the background display area into units of a (k rows×m columns) matrix region being a portion thereof during one frame but also the power consumption thereof. However, the background display area is merely selected once every frames. For that reason, even if data is not first erased in the normal display mode, the normal display on the background display area will gradually fade away to the background display. In the present invention, the normal display data are not erased after once displaying the background all over the screen, but the significant data, that is, partial or background display data, is written to all pixels in the first frame. Therefore, this invention can prevent the normal display in the background display area gradually from changing to a background display state.

As described above, the present invention can display desired partial regions and can smoothly shift a frame from a normal display mode to a partial display mode. Furthermore, because the previous normal display is not left on the background area later than the second frame in the partial display mode, a high quality of the background display can be realized. Moreover, the area selected during one frame corresponds to the partial display area as well as the (k rows×m columns) area being a portion of in the background display area. Hence, the number of rows to be selected in one frame in the partial display mode is smaller than that in the background display mode. This results in reduced power consumption.

### BRIEF DESCRIPTION OF THE DRAWINGS

These and other objects, features, and advantages of the present invention will become more apparent from the following detailed description taken in conjunction with the attached drawings, in which:

FIG. 1 is a diagram illustrating the configuration of a display device according to a preferred embodiment of the present invention;

FIG. 2(a), FIG. 2(c), and FIG. 2(c) are conceptual diagrams illustrating example displays of a display device according to the present invention;

FIG. 3(a), FIG. 3(b), FIG. 3(c), and FIG. 3(d) each are diagrams each illustrating a switching operation in a display mode and the display state thereof, according to the present invention;

FIG. 4 is a diagram illustrating the configuration of a timing controller in a driver according to the present invention;

FIG. 5 is a diagram illustrating the configuration of a V-driver for a LCD panel, according to the present invention;

FIG. 6 is a diagram illustrating the configuration of the frequency divider 11 shown in FIG. 4;

FIG. 7 is a diagram illustrating the 1H width controller 19 shown in FIG. 4;

FIG. 8 is a diagram illustrating the configuration of the MASK generator 48 shown in FIG. 4;

FIG. 9 is a timing chart illustrating an operation in a normal display according to the present invention;

FIG. 10 is a timing chart illustrating an operation in a white raster display mode according to the present invention;

FIG. 11 is a timing chart illustrating the operation in a partial display mode when the example driving methods 1 and 4 according to the embodiment of the present invention are executed;

FIG. 12 is a timing chart illustrating the operation in a partial display mode when the example driving method 1 according to the embodiment of the present invention is executed;

FIG. 13 is a timing chart illustrating the operation in a partial display mode when the example driving method 2 according to the embodiment of the present invention is executed;

FIG. 14 is a timing chart illustrating the operation in a partial display mode when the example driving methods 2 and 4 according to the embodiment of the present invention are executed;

FIG. 15 is a timing chart illustrating the operation in a partial display mode when the example driving method 3 according to the embodiment of the present invention is executed;

FIG. 16 is a diagram illustrating example pre-charge waveforms according to the embodiment of the present invention;

FIG. 17 is a diagram illustrating the configuration of a pre-charge driver 230 used in the present invention;

FIG. 18 is a timing chart illustrating the operation in a partial display mode when the example driving methods 3 and 4 according to the embodiment of the present invention are executed;

FIG. 19 is a diagram illustrating the configuration of the timing controller in a driver according to the present invention;

FIG. 20 is a diagram explaining the operation of the background area detector 60 shown in FIG. 19;

FIG. 21 is a conceptual diagram explaining a background area selecting method in a partial display mode of a display device according to the present invention;

FIG. 22 is a diagram illustrating threshold values set to, and outputs, the MASK generator 48 and the background area detector 60 when executing the method shown in FIG. 21;

FIG. 23 is a diagram illustrating the output waveform of the MASK generator 48 and the output waveform of the background area detector 60 when the method shown in FIG. 21 is executed;

FIG. 24 is a timing chart illustrating an operational example when the method shown in FIG. 21 is employed;

FIGS. 25(a), 25(b), 25(c), and 25(d) are diagrams illustrating the procedure for executing partial and background display from the transition to a partial display in a display device according to the present invention; and

FIG. 26 is a diagram illustrating the configuration of the timing controller for executing partial and background display from the transition to a partial display, in a display device according to the present invention.

### DESCRIPTION OF THE EMBODIMENT

A preferred embodiment (hereinafter referred to as the embodiment) according to the present invention will be explained below while referring to the attached drawings. [Basic Configuration]

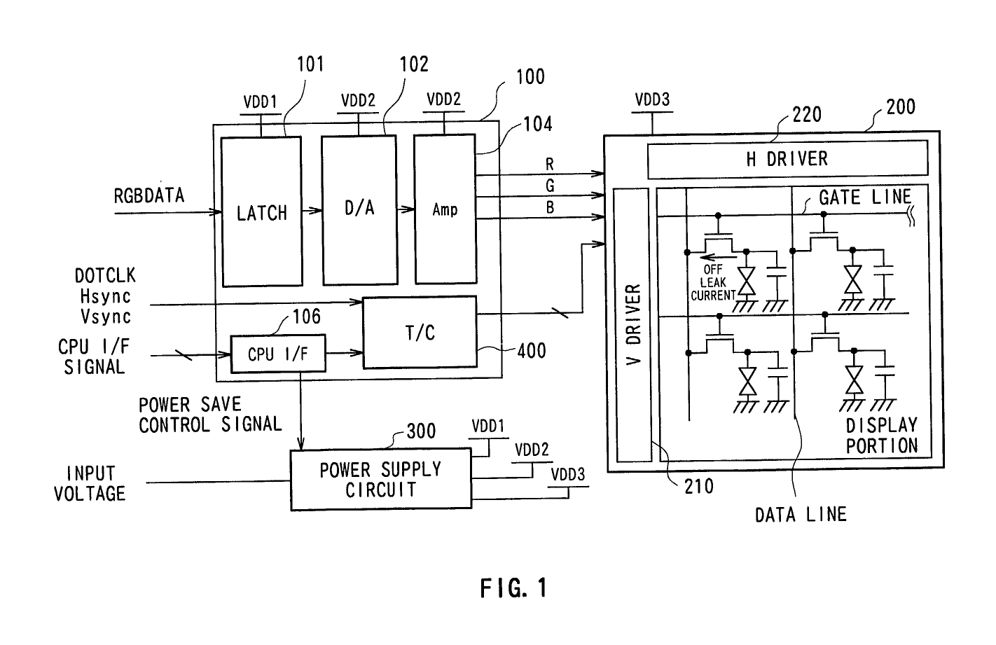

FIG. 1 schematically depicts the configuration of a display panel according to the present invention. This display panel corresponds to, for example, a flat display panel such as a Liquid Crystal Display (LCD) mounted on a mobile telephone. The display panel consists of a LCD panel 200 in which a liquid crystal is injected between a pair of substrates, a drive circuit 100 for driving the LCD panel 200, and a power source circuit (power supply circuit) 300 for supplying necessary power source voltages (e.g. VDD1, VDD2, VDD3) to the drive circuit 100 and to the LCD panel 200.

The LCD panel 200 is an active matrix-type LCD panel on respective pixels of which can be displayed an image. In the LCD panel 200, thin-film transistors acting as switching elements are arranged for respective pixels and are turned on and off with the gate lines extending in the row direction. Display data is supplied to each pixel via the thin film transistor from the data line extending in the column direction. Around the display section of the panel are arranged a vertical driver (V driver) 210 that controls the gate lines in order and a horizontal driver (H driver) 220 that supplies display data to the data line with a predetermined timing. The V driver 210 and the H driver 220 may not be formed on the panel 200 but may be formed as a part of an integrated drive circuit 100 or as a discrete circuit.

The drive circuit 100 includes a latch circuit 101 that latches RGB digital data, a digital to analog (D/A) converter 102 that converts latch data into analog data, and an amplifier 104 that amplifies converted analog data and supplies the amplified R, G and B analog data to the H driver 220 of the LCD panel 200. The drive circuit 100 also includes a CPU interface (I/F) circuit 106 that receives an instruction from a CPU (not shown) and outputs a control signal according to the instruction and a timing controller (T/C) 400. The I/F circuit 106 receives and analyzes an instruction transmitted from the CPU (not shown) and then issues a control signal according to the instruction. The instructions transmitted from the CPU include an instruction for adjusting display positions on a display panel and a contrast instruction for adjusting the contrast of a display panel, in addition to a power saving control instruction.

The T/C 400 produces timing signals and control signals necessary for the operation and display of the V driver 210 and the H driver 220 in the LCD panel 200, based on timing signals including the dot clock DOTCLK, horizontal synchronous signal Hsync, and Vertical synchronous signal Vsync. This embodiment, as described above, can partially display information at desired locations and can reduce the power consumption as necessary, according to the operation of the T/C 400.

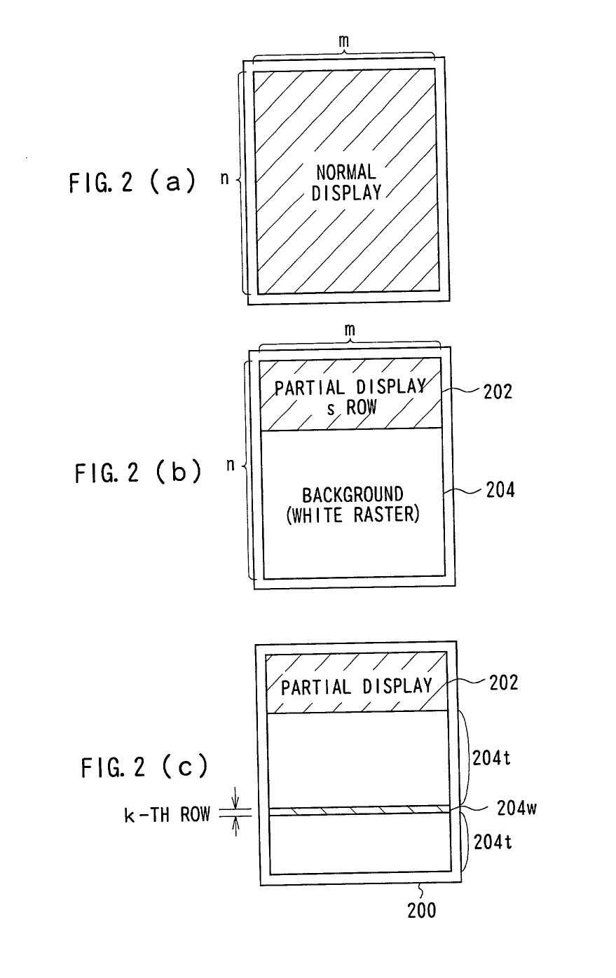

An example LCD panel 200 having pixels in a (n column×m row) matrix will next be described. In this example, all pixels are driven during one frame in a normal display mode. In order to display the entire screen in FIG. 2(a), the respective lines are sequentially selected while predetermined display data is respectively supplied to each of m column data lines. Display data is written to the pixel associated with to each column. This operation is implemented to all n lines.

For example, when the mode is changed to a partial display mode according to a power saving instruction from the CPU, an arbitrary area consisting of ((s rows from among all n rows)×m columns), as shown in FIG. 2(b), acts as a partial display area 202. Thus, a predetermined partial display is performed. The remaining area acts as a background display area (background area) 204 and performs a background display (off display). A liquid crystal layer is sandwiched between a common electrode and pixel electrodes. When a voltage of 0 volts is applied between the common electrode and pixel electrodes, (that is, in an off mode), the background area 204 displays white corresponding to the off display in the normally white mode (LCD) in which white is displayed (that is, the white raster is displayed).

In the present embodiment, the background area 204 is not continuously turned off during the partial display period. The rows, as shown in FIG. 2(c), are sequentially selected every predetermined period to write white display data to corresponding pixels. In the normally white mode, the white display is realized with, in principle, no voltage applied between electrodes. However, a voltage of several volts is actually applied between pixel electrode displaying white and the common electrode in this embodiment. Hence, in an actual display panel, the voltage corresponding to an off display is written as white display data to pixel electrodes in the background area 204 via the pixel transistors.

An example wherein n and m are both 100, such that a matrix LCD has a (100 row×100 column) screen and a partial display area 202 has an pixel area of (25 (s=25)×100) and a background area 204 has (75×100). In a manner similar to that in the partial display area 202, k row(s) in the background area 204 are selected during one frame period and write background display data is written to them (white display data to the background area). During the next one frame period, other k rows within the background area 204 are selected and white display data is written to them.

In the above example, when, in a more specific example, the background area has 75 rows and k=1. In the background area 204, the corresponding row 204w is sequentially selected for writing of white display data once every 75 frames ((n−s)/k frames). Each row of the background area 204 maintains the written white display until reselection is performed, in this case after 75 frames.

In the background area 204, white data is written into all pixels over the period of plural frames ((n−s)/k frames). For the duration of the plural frames ((n−s)/k frames) next to the duration of the frame ((n−s)/k frame), a certain row 204w within the background area 204 is inversely driven by writing white display data of which the polarity is inverted (with respect to the common electrode voltage).

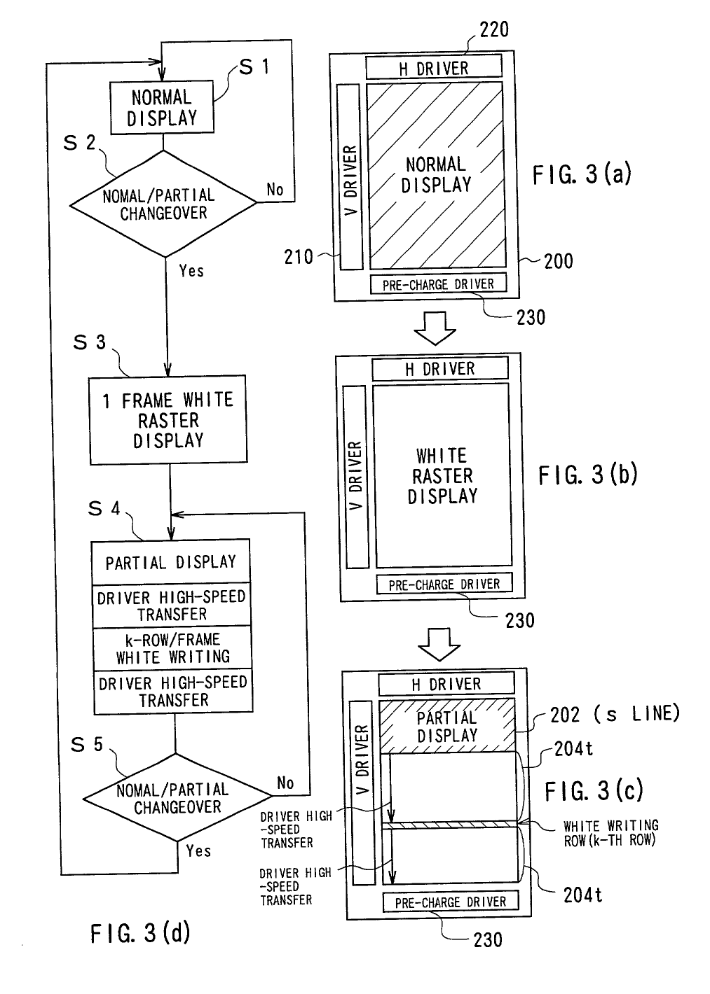

FIGS. 3(a) to 3(d) show operations in which the display panel of the present embodiment changes from a normal display mode to a partial display mode. When the I/F circuit 106 of FIG. 1 judges the normal display mode, the LCD panel 200, as shown in FIG. 3, normally displays an image over the entire screen (S1). However, when the CPU sends a partial display control instruction, the I/F circuit 106 analyzes the instruction and generates an appropriate partial display control signal, thus switching the status to the partial display mode (S2). A user-controlled switch may be provided for generating an equivalent partial control signal to change the status to a partial display mode.

After the system is changed to a partial display mode, the partial and background display may be performed directly. However, in the present embodiment, when the mode is changed from the normal display to the partial display, the entire screen is first switched to an off display mode. Specifically, one frame after shifting, respective pixels are normally selected to write white display data, thus displaying the white raster (S3 in FIG. 3(b)).

Such a control is performed in order to prevent the normal display on the background area from gradually changing to an off-display state when switching to a partial display. In other words, when the mode changes from normal display to the partial display, the pixel display data written in the previous normal frame remains displayed by the pixels in the background area 204. Because, as described above, the pixels in the background area 204 are not selected every frame, even when a pixel transistor disposed for each pixel is off controlled until the next gate line selection, the pixel display data gradually leaks to the drain line because of the off current leakage of the transistor. Finally, the potential becomes close to the potential of the common electrode confronting via the liquid crystal layer. That is, when the mode changes from the normal display frame, the background area 204 gradually changes to the off display (white raster) over several seconds. Such a slow change in display is usually not preferred by system users. To overcome such a problem, by first writing white display data once over the entire screen and displaying the white raster before the mode changes to the partial display, all pixels change from a white display state, or an off state, at the partial displaying time. Thus, the display degradation of the background area 204 can be eliminated in the partial display mode. In the following description, except where otherwise specified, the example LCD panel 200 is of a normally white type and the substantially off display is a white display.

Immediately after the white raster is displayed all over the while screen, the LCD panel 200 begins partial display (S4) as shown in FIG. 3(c). Because the T/C 400 in FIG. 1 generates the control signal and the timing signal (to be described later), based on the partial control signal, the LCD panel 200 performs the partial display. The present embodiment can be realized without providing a special configuration for a partial display to the LCD panel 200.

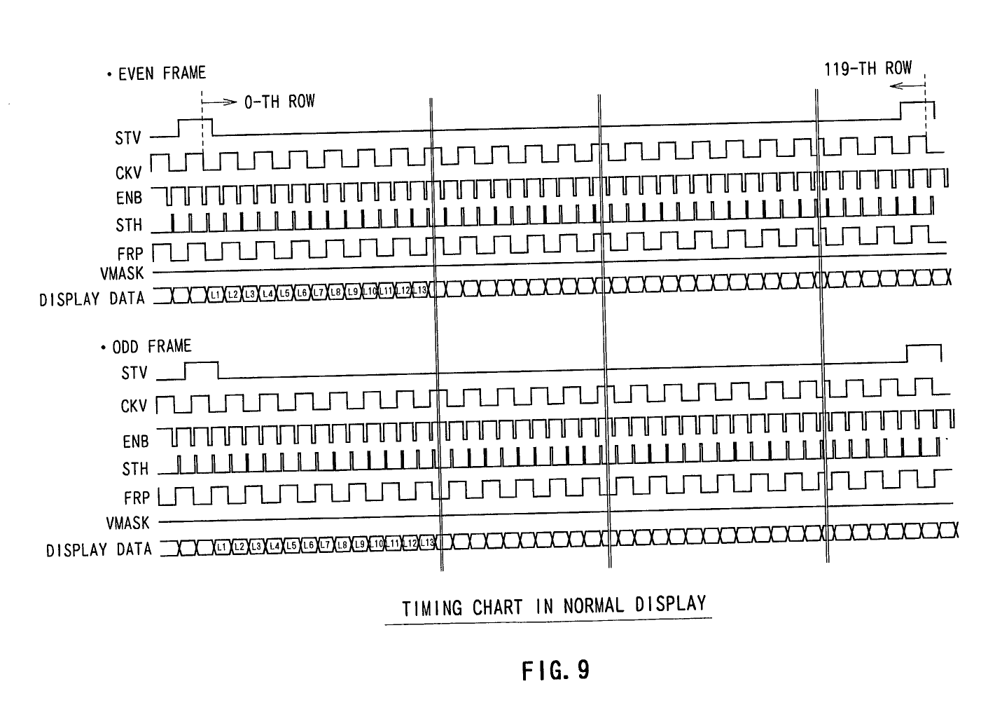

In the partial display area in a partial display mode, each row is selected in one frame, as in normal display, to write display data. Example methods 1 to 4 for driving the background area 204 according to the embodiment will be explained below while referring to FIG. 3(c). More specific examples of drive waveforms in each driving method will be described later by referring to FIGS. 9 to 15 and FIG. 18.

The CPU transmits a normal display control instruction. Then, the I/F circuit 106 of FIG. 1 analyzes the instruction and, based on the results of this analysis, either produces the normal display control signal or halts output of the partial display control signal. In such an operation, the state returns from the partial display mode to the normal display mode (S5 in FIG. 3).

### Driving Method 1

In an example driving method 1, all s rows (gate lines) in the partial display area 202 are sequentially selected during one frame period and predetermined display data is written, only the k rows in the background area 204 are selected during one frame period and white display data is written. That is, in the driving method 1, the total (s+k) rows (=s rows in the partial display area 202+k rows in the background area 204) are sequentially selected during one frame period. In a predetermined timing, the display data is issued to data lines of m columns associated with the selected rows, in a predetermined timing. Thus, sets of display data corresponding to pixels are written sequentially.

With the partial display area 202 has 25 rows and the background area 204 has 75 rows and k=1, 26 rows (25 rows+1 row) are selected during one frame period. The selection of another line 204t in the background area 204 is inhibited based on the vertical mask signal (VMASK) (a control signal to be described later) of signals generated by the T/C 400 in FIG. 1.

In the next frame, all s lines of the partial display area 202 are reselected for the writing of display data (in this case, the polarity of the display data changes every one line when line inversion occurs or every one frame when frame inversion occurs). In the background area 204, the k-th line, which is not the same line as the k-th line to which the white display data was written in the previous frame, is selected. Then, the white display data is written into the selected k-th line. Therefore, if the number of rows (S) within the partial display area 202 of all 100 rows is 25 and the number of selected rows (k) per frame in the background area 204 is 1, the display data is written into the partial display area 202 in each frame. The white display data is written onto the background area 204 over a period of 75 frames.

With k=1, when the line selected in one frame is adjacent to the line selected in the previous frame, the line inversion drive operation is performed by writing white display data with an inverted polarity to the second line.

Moreover, the white display data is written to all the pixels in the background area 204 over plural ((n−s)/k) frames (75 frames in the above example), or, in other words, over the duration of one background display period. Thereafter, the white display data with an inverted polarity is written to the same line during the next ((n−s)/k) frame.

The background area is put into a white display mode by inverting the polarity every line and every background frame. This operation prevents a dc voltage component from being continuously applied to the liquid crystal layer in the background area 204, thus preventing deterioration of the liquid crystal.

In the driving method 1, the partial display and background display are performed by repeating the above procedure in the partial display mode.

The driving method 1 can be applied where pixels are dot by dot and where they are driven line by line. In the dot sequential driving operation, when a corresponding row (gate line) is selected in a partial display area or a background area, the display data are sequentially transmitted to the data line. In the line sequential driving operation, the display data to be written to all the data lines are transmitted simultaneously.

### Driving Method 2

In example driving method 2, operation that all the rows in the partial display area 202 and k rows in the background area 204 are selected during one frame period to write the display data is common with the above method 1. In example method 2, the pixels of all rowss in the partial display area 202 are sequentially driven dot by dot (or line by line) to write the display data. Then, k lines in the background area 204 are selected by inputting the white display data to all data lines (m rows). In more detail, after the partial display area 202 has been completely driven, the white display data is written to all m data lines in the next one horizontal duration (1H: one gate line selection duration) to select k gate lines in the background area 204. This operation turns on the pixel transistors associated with the selected gate lines. Thus, the white display data supplied to the data lines is captured to display the corresponding pixels in a white state.

The rows selected in the background area 204, those to which the white display data is written, change from frame to frame, in a manner similar to the method 1. When the row within the background area 204 selected in one frame is adjacent to the row selected in the next frame, the voltages of the white display data to neighboring rows are set so as to have an inverted polarity to each other.

As in the driving method 1, the white display data is written over the entirety of background area 204 in the period corresponding to plural frames and the voltage polarity of the white display data written to the same row is inverted every other background frame.

In the driving method 1, after the line selection has been completed to the partial display area 202, the H-driver 220 does not operate until the selection period for rows within the background display area 204 to be selected in the same one frame duration. After the corresponding row is selected, the H-driver 220 again suspends operation. In contrast, in the driving method 2, after the completion of row selection to the partial display area 202, the H-driver 220 operates for only the successive 1H duration to write the white display data to each data line. Thus, operation can be ceased during selection of the remaining region of the background area 204. As with the driving method 1, this control can be easily realized by slightly modifying the T/C 400 or by adding a minimum configuration.

### Driving Method 3

In an example driving method 3, the white display data is written to k lines of the background area 204 using the pre-charges control signal. In an active matrix-type LCD, a corresponding gate line is normally selected during 1H period to turn on the pixel transistor. During this operation, the display data applied to the data line is written to each pixel via the corresponding pixel transistor to display each pixel. However, in a line inverse-driving scheme, the polarity of the display data applied to a data line is inverted every 1H. Hence, it is desirable that the data line be quickly and reliably set to the voltage of the next display data to be displayed. For that reason, a pre-charge operation is for writing a voltage close to a display data voltage into each data line is performed, the display data voltage then being written into the data line in the following 1H duration. Particularly, in a p-Si TFT LCD using a polycrystalline silicon for the active layers of thin-film transistors, a dedicated pre-charge driver 230, shown in FIG. 3, is formed in the LCD panel 200, together with other drivers 210 and 220 to reduce the TFT operational load. In this manner, the pre-charge driver 200 implements pre-charging driving.

In the driving method 3 according to the present embodiment, the pre-charge control signal and the pre-charge data, for pre-charging, are used to perform a background display on the background area 204. That is, when a selection timing for a row to be selected on the background area 204 occurs during a frame period, the T/C 400 (FIG. 1) generates a pre-charge control signal (PCG) immediately before the beginning of 1H. The pre-charge data corresponding to white display data is written into each data line, according to the control signal. In the partial display area 202, predetermined pre-charge data in accordance with the level of partial display data to be displayed in a corresponding row immediately before row selection is supplied to each data line by the pre-charge control signal. The predetermined pre-charge data may be set to a fixed level, independently of the level of partial display data.

Identical to the methods 1 and 2 are changing a row (gate line) selected every frame in the background area 204, inverting the polarity of white display data every line, and inverting the polarity of white display data every background screen.

By writing the white display data into k lines on the background area 204 using the pre-charge control signal, it is unnecessary to control the H-driver 220 during the background display period. This contributes to reducing power consumption.

### Driving Method 4

In an example method 4 of the present embodiment, k lines selected on the background area 204 during one frame are driven according to any one of the driving methods 1 to 3. The frequency of the pulse controlling the length of a 1H duration is increased during the period corresponding to the selection duration of the (n−s−k) lines not selected. Thus, each selection pulse is transferred at high speed within the line driver (V-driver 210).

The drive operation enables each row to be driven with a frequency lower than that in the normal (n-row drive) operation when the number of lines to be displayed during one frame period is (n+k). Moreover, the drive operation can reduce power consumption by the digital, which depends on the operation frequency.

The selection pulse is output within the V-driver 210 for a duration corresponding to the rows within the background area 204 not selected during one frame, without halting of the v driver 210. Thus, the selection pulse selecting each row is not output to the row, but is transferred at high speed. Hence, when a target row is next driven with the selection pulse, the selection pulse can be immediately output to a necessary row (gate line), without a special pulse output operation.

As described above, in the partial display mode, the transfer frequency of the selection pulse for selecting rows by the V-driver is partially increased so that the operational frequency of the whole display panel is decreased. Power consumption is reduced as a result of the decreased drive frequency without changing the design of the internal driver in the LCD panel 200. This enables the partial display in the power saving mode.

### Drive Circuit

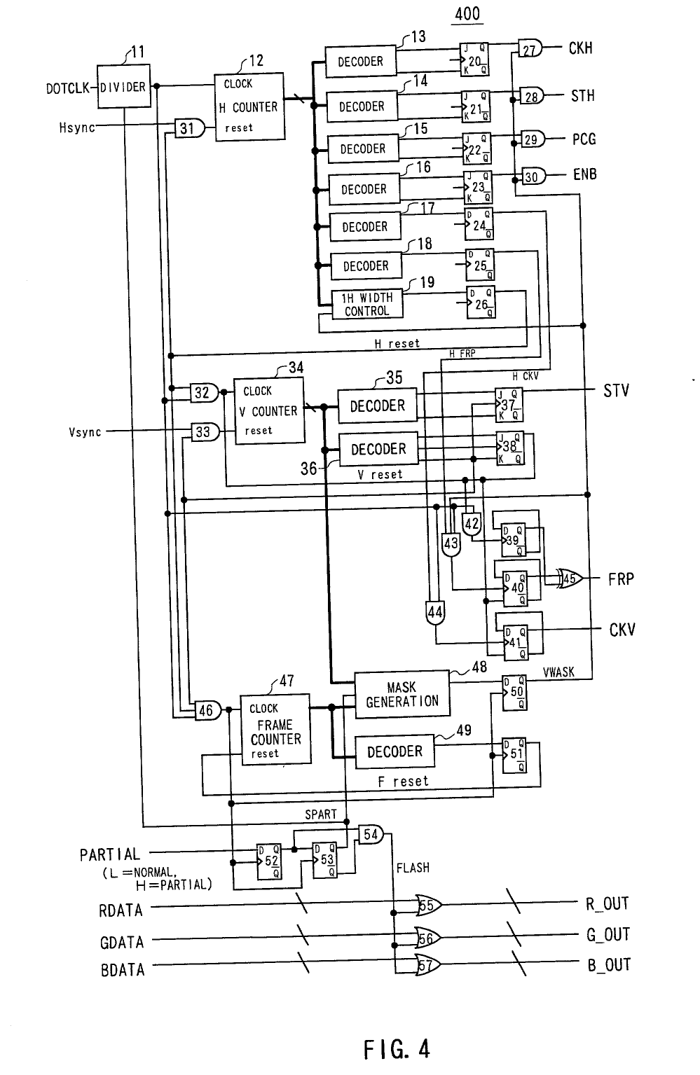

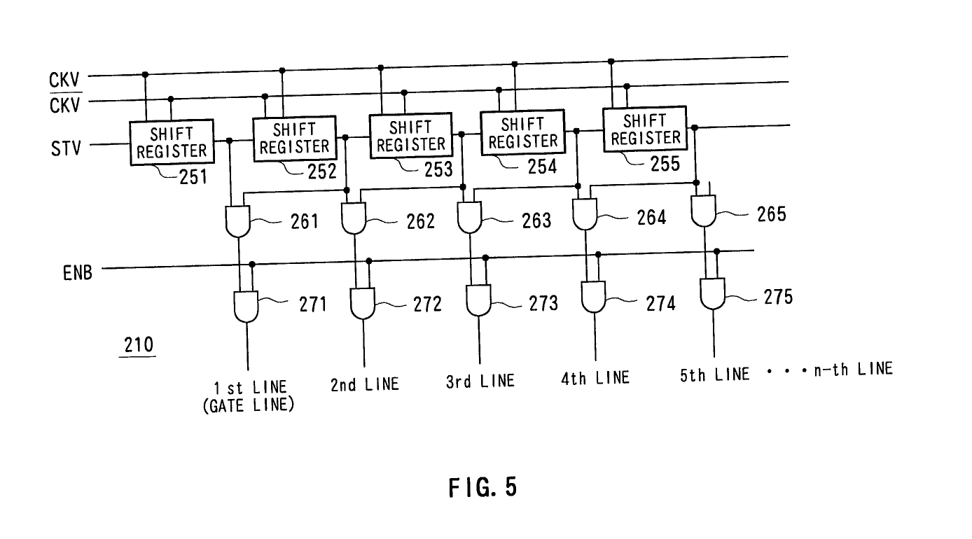

Next, an example of configuration of a drive circuit according to an embodiment realizing the above-described drive operation will be described below. FIG. 4 depicts the configuration of the T/C 400 within the drive circuit 100 in FIG. 1. FIG. 5 depicts the configuration of the V-driver 210 incorporating in the LCD panel 200 in the present embodiment.

The dot clock (DOTCLK), the horizontal synchronous signal (Hsync), the vertical synchronous signal (Vsync), and the partial display control signal (PARTIAL) are supplied to the T/C 400. The horizontal clock (CKH), the horizontal start pulse (STH), the pre-charge control signal (PCG), the gate line selection control signal (ENB), the vertical clock (CKV), the vertical start pulse (STV), and the polarity inversion control signal (FRP) are generated based on the above-described signals. The generated signals are supplied to the V-driver 210 and the H-driver 220 in the LCD panel 200.

The H-counter 12 counts as a clock the dot clock (DOTCLK) supplied via the frequency divider 11. The H-counter 12 also counts the dot clock every 1H duration because the count value is reset with the horizontal synchronous signal (Hsync) output once in 1H duration and the H reset signal (Hreset) from the 1H width control circuit 19 (to be described later), via the AND gate 31.

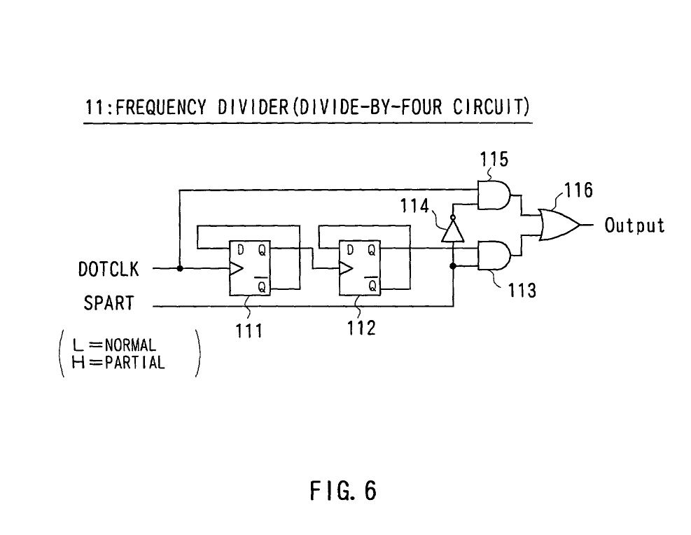

The frequency divider 11, as shown in FIG. 6, consists of F/Fs 111 and 112 in a two stage connection, AND gates 113 and 115, an inverter 114, and an OR gate 116 which selects and outputs the dot clock and the frequency division clock. When, for example, only k lines in the background area 204 are selected during one frame period, as in the above-described driving method 4, the frequency divider 11 divides the normal dot clock (DOTCLK) and then supplies the frequency divided clock to the H-counter 12, the V-counter 34 (to be described later), and the frame counter 47. Thus, the circuit operational speed in the partial display mode is decreased so that the power consumption is saved.

The H-counter 12 outputs the dot clock count value to the decoder 13. The pulse signal decoded by the decoder 13 is output as the horizontal clock (CKH) via the flip-flop (F/F) 20 and the AND gate 27. The result signal is output to the H-driver 220 in the LCD panel 200.

The decoder 14 generates a pulse determining the start timing during each 1H horizontal scanning period, based on the dot clock count value of the H-counter 12. The pulse is output as the horizontal start pulse (STH) via the F/F 21 and the AND gate 28.

Based on the dot clock count value of the H-counter 12, the decoder 15 acquires the timing immediately before the beginning of one horizontal duration to generate a pulse signal. The pulse signal is output via the F/F 22 and the AND gate 29 as the pre-charge control signal (PCG) which brings close to the display data voltage in 1H duration following the voltage of the data line immediately before the beginning of 1H.

The decoder 16 acquires the timing for controlling the selection allowable duration of each gate line based on the dot clock count value of the H-counter 12. The timing is output as the gate line selection control signal (ENB) via the F/F 23 and via the AND gate 30. During the pre-charge period effected to the date line immediately before the beginning of 1H, the control signal (ENB) inhibits the pre-charge data from being written into any pixel when a pixel transistor is turned on by the selection of a gate line. The gate line selection control signal (ENB) is supplied to the V-driver 210 in the LCD panel 200 shown in FIG. 5.

The V-driver 210 (FIG. 5) includes plural stages of shift registers 251, 252, . . . ; AND gates 261, 262, . . . each of which outputs a logical product of the output of the y-th shift register and the output of the (y+1)-th shift register; and final output gates 271, 272, . . . to gate lines. Each of the shift registers 251, 253, . . . sequentially shifts the vertical start pulse (STV) in accordance with the number (n) of gate lines of the panel, with the vertical clock (non-inversion CKV and inversion CKV) (to be described later) acting as a clock signal. The gate line selection control signal (ENB) is supplied to one input terminal of each of the final output gates 271, 272, . . . 27n. Because the control signal (ENB) becomes an L level during the pre-charge period immediately before the beginning of the 1H duration, the gate selection signal is inhibited from being output to the gate line while the control signal (ENB) is at an L level.

The decoder 17 decodes the dot clock count value from the H-counter 12 and supplies the decoded value to one input terminal of the AND gate 44 via the F/F 24. The frequency divider 11 supplies the dot clock (DOTCLK) to the other input terminal of the AND gate 44. Because the frequency divider 11 does not implement the frequency division in the normal display state, the AND output of the gate 44 is nearly equal to the dot clock. The F/F 41 receives the dot clock and outputs a signal changing its level every 1H, from its Q terminal. The level changing signal is output as the vertical clock (CKV) to the V-driver 210 in the LCD panel 200.

The decoder 18 generates a pulse signal based on the dot clock count value of the H-counter 12. The decoder 18 supplies the pulse signal to an input of the AND gate 43 via the F/F 25. The AND gate 43 supplies the clock to the F/F 40. The F/F 40 outputs an inversion control signal (FRP) to invert display data every 1H.

The 1H width control circuit 19 generates an H reset signal (Hreset) once in the 1H duration corresponding to one selection duration of each gate line and acts a part of the row clock generator, together with the AND gate 32 and the V-counter 34 (to be described later). As explained in the driving method 4, the 1H width control circuit 19 speeds up the output timing of the H reset signal (Hreset) acting as the reference to the 1H duration and 1V (one frame) duration, within the I/C 400. Thus, the data processing time for rows not selected in the background area is shortened. As a result, the transfer rate of the gate selection pulse by the V-driver (FIG. 5) is improved.

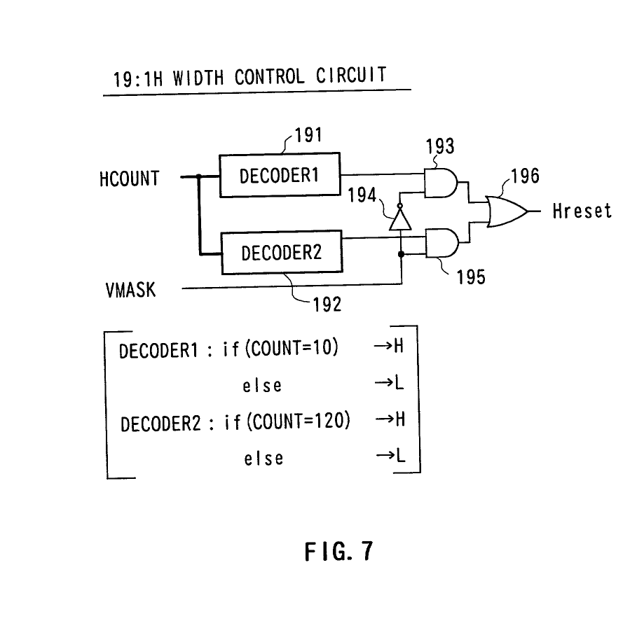

The 1H width control circuit 19, shown in FIG. 7, includes a decoder 191, a decoder 192, gates 193 and 195, and an OR gate 196. The decoder 191 outputs “H” when the H-counter value is a high-speed reset set value “10”. The decoder 192 outputs “H” when the H-counter value is a normal reset set value “120”. The gate 193 produces a logical product of an output of the decoder 191 and an inverted version of the V MASK signal (VMASK) (to be described later). The gate 195 produces a logical product of an output of the decoder 192 and the V MASK signal (VMASK) not inverted. The OR gate 196 produces a logical sum of outputs from the two AND gates. Because of the background area 204, for the period during which the V MASK signal (VMASK) is at an L level and selection is carried out during the L level, the inverter 194 supplies the inverted MASK signal to the AND gate 193. This operation allows the AND gate 193 to output the output of the decoder 191. Normally, the H reset pulse (Hreset) output with the count value of m (where, for example, m=120 and m including a blanking duration) can be output when the H-counter counts 10.

The V-counter 34 receives the output of the AND gate 32 as a clock and is reset by the output from the AND gate 33. The AND gate 32 receives an H reset pulse (Hreset) from the 1H width control circuit 19 and the dot clock (DOTCLK) supplied via the frequency divider 11. The V counter 34 counts pulses changing to H once every 1H and resets its count value in accordance with the vertical synchronous signal (Vsync) every 1V duration.

The decoder 35 outputs the vertical start pulse (STV) representing the start of 1V duration once every one vertical scanning duration (1V) via the F/F 37, based on the count value of the V counter 34.

The decoder 36 outputs the V reset pulse (Vreset) via the F/F 38 when the count value of the V counter 34 reaches a numerical value corresponding to the number of lines (the number (n) of gate lines) of the LCD panel 200. The V reset signal (Vreset) is supplied to the reset terminal of the F/F 40 to reset an inverted pulse (FRP) which inverts the polarity of display data every 1H and every one frame. The V reset signal is also supplied to the reset terminal of the F/F 41 to reset the V clock (CKV). The V reset pulse is supplied to the AND gate 42 which produces a logical product of the dot clock (DOTCLK) and the dot clock (DOTCLK). The F/F 39 receives the AND output of the gate 42 at its clock terminal and generates a Q output which is inverted every other frame.

The EXOR gate 45 produces an exclusive logical sum of the output of the F/F 39 and the output of the F/F 40 and then outputs it as a polarity-inverted pulse (FRP) to the H driver 220 of the LCD panel 200.

Moreover, as shown in the lower side of FIG. 4, the configuration of the present embodiment includes a frame counter 47, a MASK generator 48, a F/F 50, a decoder 49, and a F/F 51. A combination of the MASK generator 48 and the F/F 50 generates and outputs a MASK signal (VMASK) in accordance with a frame count value. A combination of the decoder 49 and the F/F 51 decodes the frame count value and then resets it.

The frame counter 47 counts the output from the AND gate 46 which makes a logical product of a V reset (Vreset), an H reset (Hreset), and a dot clock (DOTCLK). The AND gate 46 produces its output which changes to an H level once during 1V period, that is, once during one frame period. The frame counter 47 counts the AND output, that is, the number of frames. The counted number is output to the MASK generator 48 and the decoder 49.

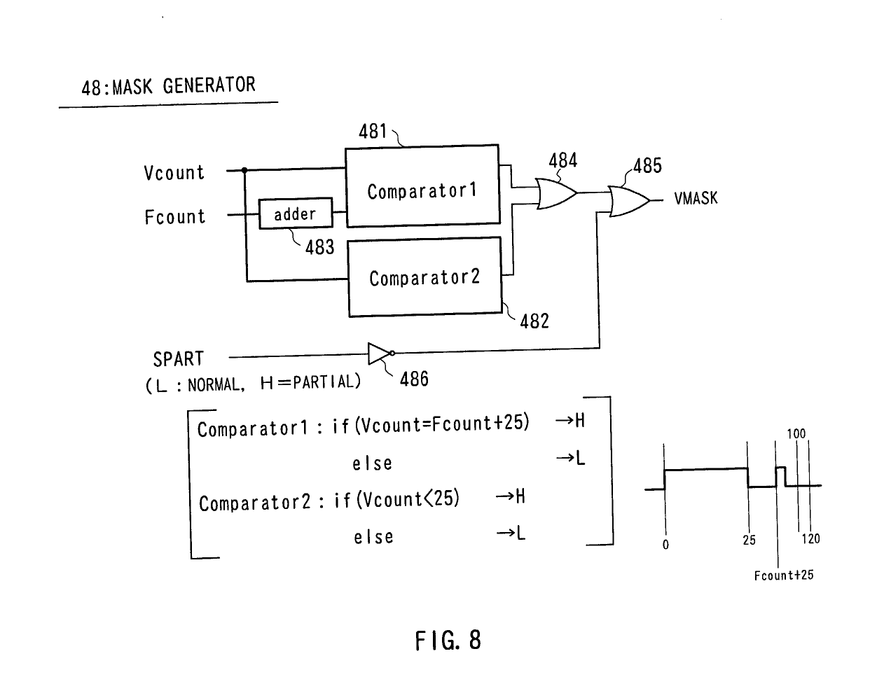

The MASK generator 48, as shown in FIG. 8, includes comparators 482 and 481, and an adder 484. The comparator 482 corresponds to a partial display row detector which detects the coming timing for a partial display row The comparator 481 detects the incoming row to which off display data is written within the background area. The MASK generator 48 also includes OR gates 484 and 485 and an inverter 486. The adder 483 adds an arbitrary settable value, for example, “25” to the frame (F) count value and then outputs the resultant value to the comparator 481.

The comparator 481 compares the V count value from the v counter 34 with (an F count value+a set value of “25”). The comparator 481 produces an H level when the V count value from the v counter 34 becomes (a F count value+a set value of “25”) and produces an L level when the V count value from the v counter 34 becomes another value. The comparator 482 produces an H level when the V count value is a value arbitrarily set in accordance with a target partial display position is, for example, less than “25”. The comparator 482 produces an L level when the V count value is “25” or more.

The OR gate 484 outputs an H level signal for the period during which the V count value is 0 to 24 and (F count value+25). The OR gate 485 outputs the output from the gate 484 as the V MASK signal (VMASK) via the F/F 50 only when the partial display start signal (SPART),to be described later, is at an H level (in a partial display mode).

Because the start signal (SPART) is maintained at L level at the normal display time, the OR gate 485 always receives “H” via the inverter 486 such that the V MASK signal (VMASK) maintains its H level.

Each of the AND gates 27 to 30 receives the V MASK signal (VMASK) at its one terminal. Each AND gate inhibits the H clock (CHK), the H start pulse (STH), the pre-charge control signal (PCG) and the enable signal (ENB) from being output when the V MASK signal is at an L level. The 1H width control circuit 19 receives the V MASK signal and produces an H reset pulse (Hreset), with the timing at which the H count value is 10 for 1H duration, only when the V MASK signal is at an L level. The AND gate 43 receives the V MASK signal at its input terminal and sustains the output of the F/F 40 when the V MASK signal is at an L level. As a result, the AND gate 43 sustains the level of the polarity inverted signal (FRP) to a fixed value for the duration.

The decoder 49 sets ((n−s)/k) in accordance with (n−s) lines of the background area 204 and with k lines of the background area 204 selected during one frame period in the partial display mode. For example, with n=100, s=25 and k=1, the F count value is set to “75”. “75” means that a pulse is output in the 75-th frame in a partial display mode.

The pulse is supplied as the F reset pulse (Freset) to the frame counter 47 via the F/F 51. The frame counter 47 rests its count value every ((n−s)/k) frames (75 frames) in the partial display mode.

The F/F 52 receives at the D terminal the partial display control signal (PARTIAL) output from the I/F circuit 106 (FIG. 1) in the partial display mode and operates with the output (acting as a clock) of the AND gate 46. The AND gate 46 produces a logical product of the V reset (Vreset), the H reset (Hreset) and the dot clock. Because the AND gate 46 supplies a pulse signal rising once every 1V duration, the F/F 52 first captures the partial display control signal in the next 1V duration and then outputs it from its Q terminal.

The F/F 52 supplies the Q output to one terminal of the W15 AND gate 54 and to the D terminal of the F/F 53. Like the F/F 52, the F/F 53 receives as a clock the output from the AND gate 46. The F/F 53 produces from its Q terminal the partial display start signal (START) of H level after a lapse of 1V duration from a partial display instruction and outputs it to the MASK generator 48 and the frequency divider 11. The F/F 53 supplies the inverted Q output to the other input of the AND gate 54. The AND gate 54 outputs the flash signal (FLASH) which maintains an H level for only the next 1V period during which the partial display control signal (PARTIAL) is at an H level and which maintains it to an L level in other duration.

The OR gates 55, 56 and 57 receive the flash signal (FLASH) at their terminals and produce the R, G and B digital signals, each which is at an H level, when the flash signal becomes H level.

When all of the R, G and B digital outputs are at an H level, a white display is generated. The R, G and B digital signals are output to the digital processing circuit such as the latch circuit 101 (FIG. 1). The amplifier 104 outputs, as R, G and B analog display signals for white display, the converted signals to the H driver 220 in the LCD panel 200 via the D/A converter 102.

In the above-described configuration, when the partial display control signal becomes H level, the entire screen is subjected to a white display (a white raster display) in the next one frame, as shown in FIG. 3. After a lapse of time period corresponding to one frame from an instruction has passed, the F/F 53 outputs the partial display start signal (SPART) to start the partial display operation.

### Operation of Display Panel

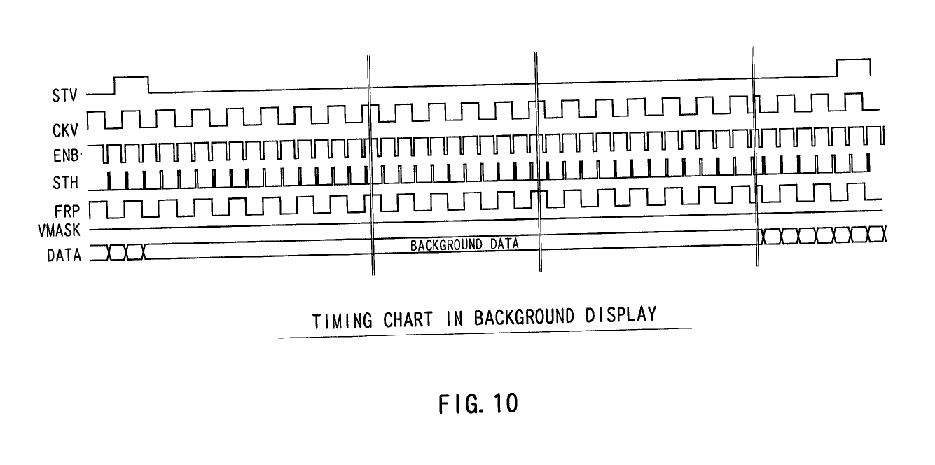

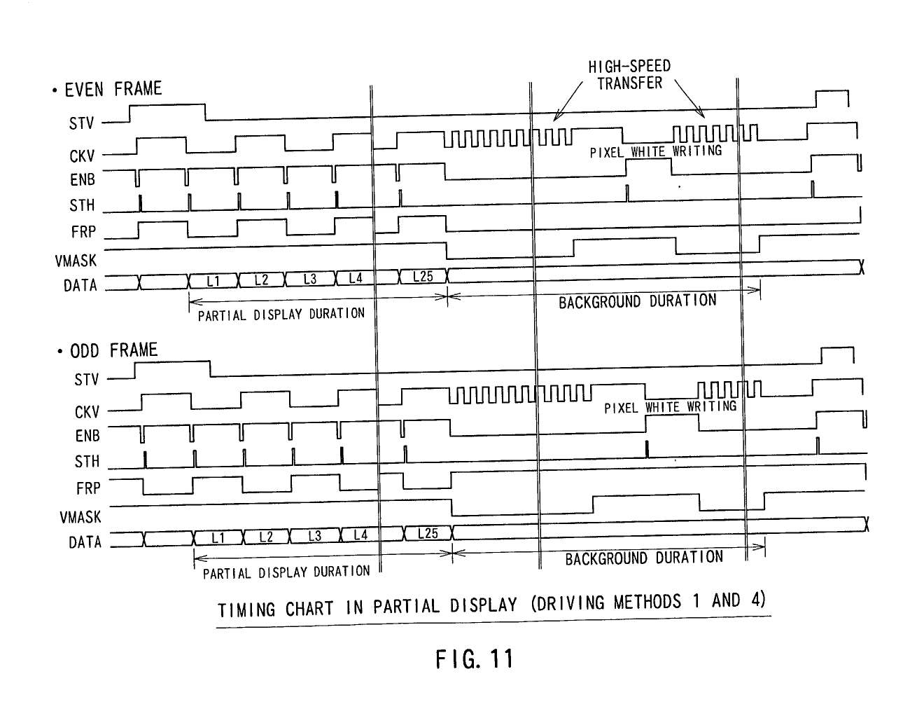

Next, the operational timing of a display panel embodying the above configuration will be described with reference to FIGS. 9 to 11. FIG. 9 shows a timing chart for a normal display mode. FIG. 10 is a timing chart for a white-over-screen display mode. FIG. 11 shows a timing chart for a partial display mode employed in the driving methods 1 to 4.

### Normal Display

Because the partial display control signal (PARTIAL) is maintained at L level in a normal display mode, the V MASK signal (VMASK) sustains an H level. In the even frame and the odd frame, because the 1H width control circuit 19 outputs an H reset pulse (Hreset) in accordance with m data lines, the 1H duration and the V clock (CKV) are maintained constant. Any one of the H clock (CKH), the H start pulse (STH), the pre-charge control signal (PCG), or the enable signal (ENB) can be output.

When the V driver 210 in the LCD panel 200 (FIG. 5) outputs the V start pulse (STV), signals which selects each gate line in accordance with the V clock (CKV) for 1H is sequentially generated. While the enable signal (ENB) is at an H level, the gate selection signal is sequentially output to the corresponding gate line. When the H start pulse (STH) is output, the H driver in the LCD panel 200 sequentially outputs the display data to be written to each pixel associated with a gate line selected by the V driver 210 to the corresponding data line, in accordance with the H clock (CKH).

In the above operation, the V driver 210 sequentially selects the gate lines. H driver 220 sequentially outputs display data to the corresponding data lines and turns on the pixel transistors respectively connected to the selected gate lines. Thus, the H driver 220 writes the display data to each pixel via the corresponding data line and the corresponding pixel transistor. This operation is repeated in each frame to display an arbitrary pixel.

The polarity inverted control signal (FRP) is 1H or the polarity of the control signal is controllably inverted for each line. Thus, in accordance with the inversion of the polarity inverted control signal (FRP) the display data is inverted and applied to each pixel. Since the control signal (FRP) is inverted in an even frame and in an odd frame, the display data with an inverted polarity is supplied to the same line every frame.

### White Raster Display

As described above, when the partial display control signal (PARTIAL) supplied from the I/F circuit 106 to the T/C 400 (FIG. 1) changes from L level (normal display) to H level (partial display), the AND gate 54 outputs the L level flash signal (FLASH) for the successive 1V duration. As a result, all the R, G, and B display data, shown in FIG. 10, become white data for 1V (one frame) duration. In this white display mode, other timing signals are identical to those in the normal display mode explained with FIG. 9. When the V start pulse (STV) is output, in a manner similar to that in the normal display mode, the V driver 210 sequentially selects the gate lines. When the H start pulse (STH) is output, the H driver 220 sequentially outputs white data to each data line. Hence, white is displayed all over the screen for one frame duration.

### Partial Display (Driving Method 1 and Driving Method 4)

FIG. 11 illustrates operation of driving methods 1 and 4 using the configuration depicted in FIG. 4 in a partial display mode. That is, the operational rate is decreased during one frame period and partial display to a predetermined position and white display on the remaining background area is implemented. In this way, power consumption by the drive circuit is further reduced. The operational speed during one frame period can be reduced because high speed transfer control of the V driver is performed by the 1H width control circuit 19 of FIG. 4 and because the frequency divided signal of the frequency divider 11 is used as the dot clock (DOTCLK).

When the partial display control signal (PARTIAL) changes to H level, an all white screen is displayed in one first frame. In the next frame, the partial display signal (SPART) changes from L level to H level. Hence, in the frequency divider 11 shown in FIG. 6, the AND gate 115 inhibits the dot clock (DOTCLK) from being output. In this case, the dot clock divided by ¼ with the F/Fs 111 and 112 (hereinafter referred to as a divided dot clock) is output via the AND gate 113 and the OR gate 116. The circuit that operates in accordance with the divided-by-four 4 dot clock reduces the operational speed to ¼. The frequency of each of the control signals (CKH, CKV, ENB, STH, FRP, and so on) shown in FIG. 11 is reduced to ¼.

In the MASK generator 48, the OR gate 85 selects the comparison outputs from the comparators 481 and 482. Referring to FIG. 8, the comparator 482 and the adder 483 are set, for example, to the set value corresponding to 1 to 25 lines at the partial display position. In such a case, the OR gate 485 outputs the V MASK signal (VMASK) being at an H level for the period during which the V count value is 0 to 24 and for the period during which the V count value is (a frame count value+25). In the V driver 210, which sequentially selects gate lines from the first one, an enable signal (ENB) generated based on the MASK signal (VMASK) is first supplied while 1 to 25 lines are partially displayed. The duration (partial display duration) allows an H level enable signal (ENB) to the V driver 210 to be output and allows the selection pulse to output to each line (row). In a manner similar to that in the normal display mode, the V driver 210 outputs a gate selection pulse to each gate line for the period during which the enable signal (ENB) is at an H level. However, the V driver 210 operates according to the V clock (CKV) having ¼ of the frequency at a normal state generated based on the divided-by-four dot clock. In a manner similar to that in the normal state, the H driver 220 sequentially outputs write display data (partial display data) to the pixels corresponding to the gate line selected to the data line during 1H period. However, each of the H driver (CKH) and the V clock (CKV) has ¼ of the frequency in the normal state.

When the v count value is out of the partial display area, the MASK generator 48 changes the V MASK signal (VMASK) to an L level. The V driver 210 inhibits the gate line from being selected for the period during which the V MASK signal (VMASK) is at an L level and maintains the inversion operation of the polarity inversion signal (FRP) in the immediate previous state.

When the V MASK signal (VMASK) is changed to L level, the 1H width control circuit 19 outputs, for example, the H reset pulse (Hreset), normally output at the H count value of 120, at the time the H count value reaches 10, as shown in FIG. 7. This operation shortens the output period of the H reset pulse (Hreset), thus speeding the counting process of the H counter 12. The period of the V clock (CKV) from the F/F 41, generated in accordance with the H count value, is shortened as shown in FIG. 11. In the V driver 210 in the LCD panel 200, the shift register 251, . . . , as shown in FIG. 5, operates with the V clock (CKV) acting as a shift clock. The V clock (CKV) speeded accelerates the transfer rate of the shift register in the V driver 210.

In the background display duration, when the comparator 481 of the MASK generator 48 selects a line to be selected in the background area, the V MASK signal (VMASK) is changed in an H level for just the corresponding line selection duration, as shown in FIG. 11. Thus, in a manner similar to that as in the partial display, the V driver 210 outputs a selection signal to the corresponding gate line for an H level duration of the V MASK signal (VMASK). When the H start pulse (STH) is output, the H driver 220 sequentially writes the white display data with the polarity determined by the polarity inverted control signal (FRP). Thus, predetermined lines in the background area 204 selected during one frame period, in a manner similar to that in the partial display area, such that white display data is written in them.

During the partial display period of the odd frame following the even frame, shown in FIG. 11, the polarity inverted control signal (FRP) is inverted with respect to that in the even frame. The operation in the odd frame is substantially the same as that in the even frame, with the significant exception that display data with a polarity inverted to that in the even frame is written to each pixel. During the background display period in the odd frame, the timing with which the V MASK signal (VMASK) once changed to an L level returns to an H level is delayed by the 1H duration because the MASK generator 48 (FIG. 8) outputs the F count value one larger than that in the previous frame (even frame), and selects the next line selected in the previous frame. At this time, the level of a polarity inverted control signal (FRP) is inverted to that in the even frame. Hence, the H driver 220 outputs the white display data with a polarity inverted to that in the previous frame to each data line and writes it into an pixel corresponding to the selected gate line.

By repeating the above-described operation, the display data is written to the partial display area 202 every frame, as shown in FIG. 3(c). During the period (204t) corresponding to lines (gate lines) not selected, high speed transfer is performed within the V driver 210. Thus, the V driver 210 selects only the predetermined lines and writes the white display data into them. In the case of the setting shown in FIG. 8, the white display data is written over the entire background area 204. In the next 75 frame, because the level of the polarity inverted control signal (FRP) is inverted to that in the previous 75 frame, the white display data having the polarity inverted to that in the 75 frame is written to the same gate lines.

### Partial Display (Driving Method 1

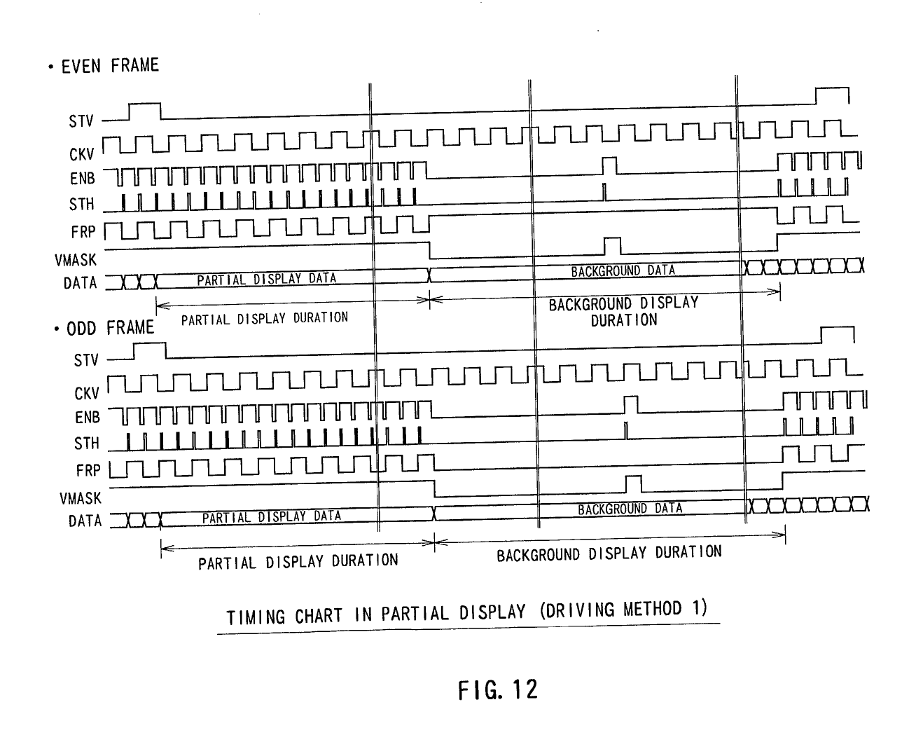

Next, the operational timing in the example driving method 1 will be specifically explained by referring to FIG. 12. The high-speed transfer of the V driver 210 is not implemented in the driving method 1. In the configuration shown in FIG. 4, the frequency driver 11 does not implements the frequency dividing operation and the 1H width control circuit 19 does not speed the output period of an H reset pulse for the background display duration. This timing chart differs from that in FIG. 11 in that the period of the V clock (CKV) is constant, regardless of the level of the V MASK signal (VMASK). Other operations are similar to the partial display operation and the background display operation, explained with FIG. 11. In the driving method 1, the drive frequency not varied in the partial display mode, as described with FIG. 11, results in the unchanged power consumption of the digital circuit system. However, the partial display can be implemented at arbitrary positions through the setting by the MASK generator 48 (comparators 481 and 482 and adder 483). Any number of lines on the background area can be selected during one frame to write the white display data to them.

### Partial Display (Driving Method 2

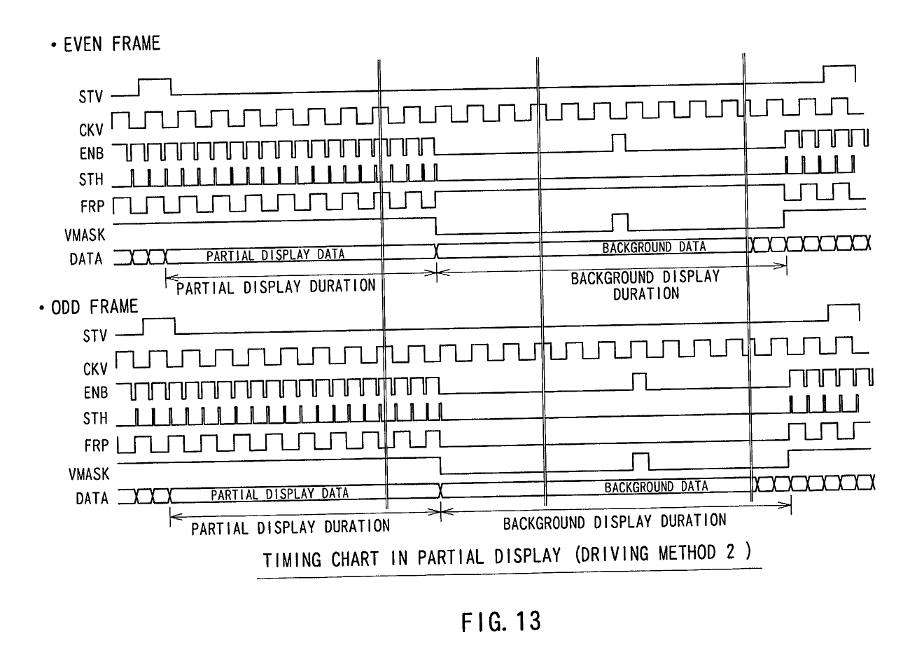

Next, the operation timing in the example driving method 2 will be explained below by referring to FIG. 13. Like the driving method 1 in FIG. 12, the driving method 2 does not to implement the high-speed transfer of the V driver 210 and the reduction of the drive frequency. The driving method 2 differs from the driving method 1 (FIG. 12) in that the H start pulse (STH) is output during the first 1H period after the beginning of the background display duration and in that the H driver 220 writes the white display data into the data line according to the H start pulse. For that reason, when the V MASK signal (VMASK) becomes an H level during the background display period to select a gate line corresponding to the V driver 210, the white display data already written to each data line is immediately written to the corresponding pixels.

### Partial Display (Driving methods 2 and 4

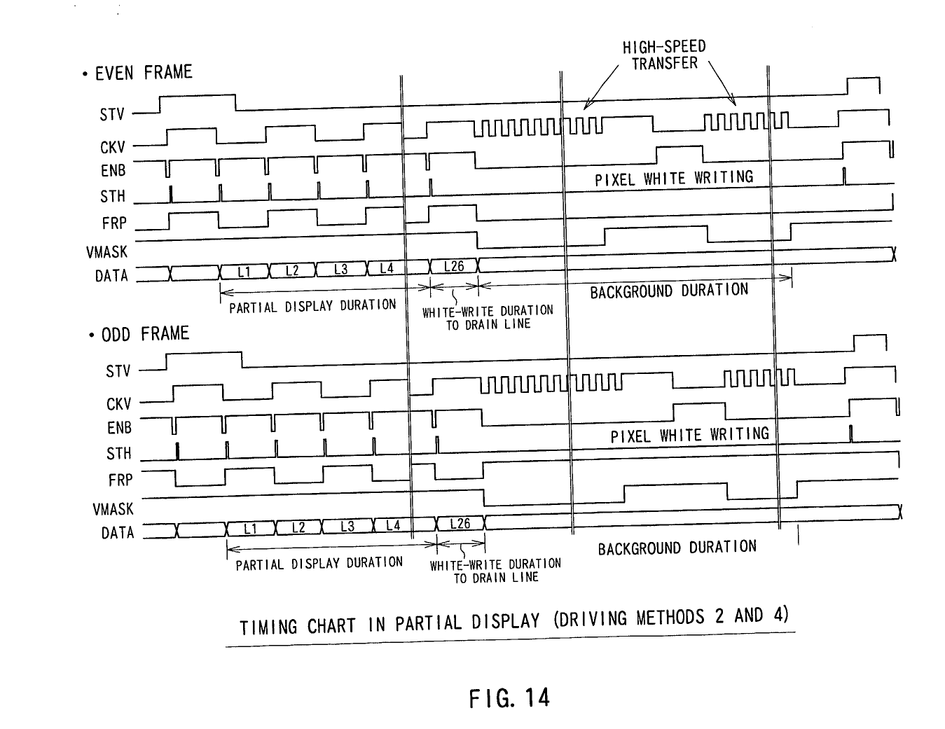

FIG. 14 specifically shows the operational timing in a combination of the driving methods 2 and 4. The difference between the combined method and the method shown in FIG. 13 is similar to that between the methods shown in FIGS. 11 and 12. That is, in the partial display mode, the operational frequency of each circuit is decreased using the frequency divider 11 shown in FIG. 4. The periods of each of CKV, ENB, FRP, VMASK, and display data are longer than that in the normal display operation. In the first 1H of the background display duration, the white display data is written to the data line and the gate line to be selected in one frame of the background area is completely selected. Thereafter, the output timing of the H reset pulse (Hreset) is sped using the 1H width control circuit 19. Finally, the fast output timing increases the frequency of the V clock (CKV) acting as data transfer clock for the shift register in the V driver 210 within the LCD panel 200. As shown in FIG. 14, the gate selection pulse is fast transferred within the V driver during the period over which the V MASK signal is at an L level.

### Partial Display (Driving Method 3

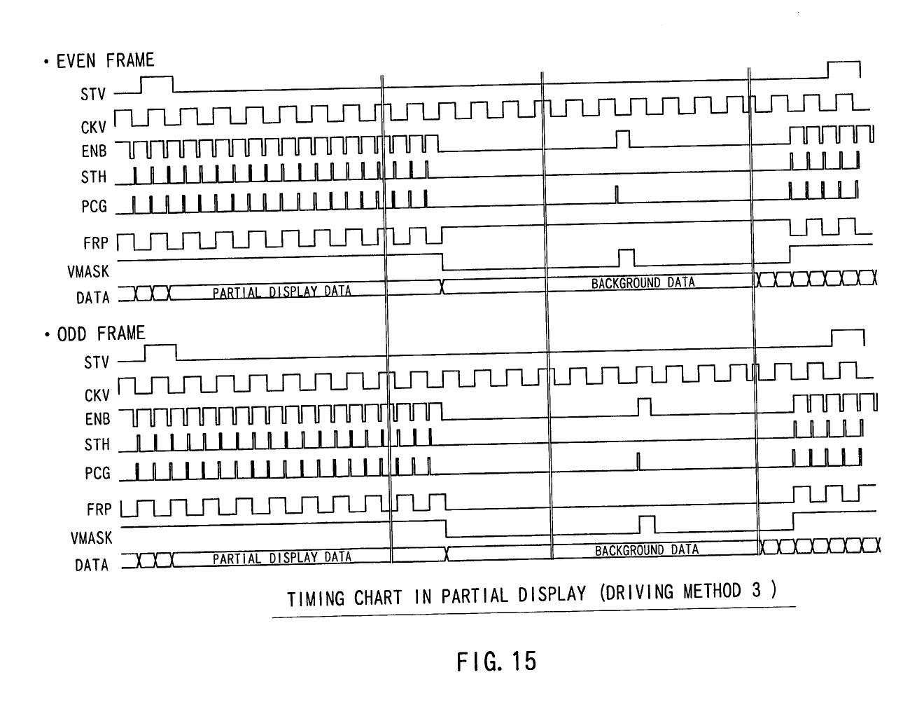

FIG. 15 depicts a specific example of operational timing in the driving method 3. This method does not implement the pulse high-speed transfer by the V driver 210 and the reduction of the drive frequency as in the driving method 1 shown in FIG. 12. In the method shown in FIG. 12, when the V MASK signal (VMASK) becomes H level during the background display period, the H driver 220 writes the white display data to the data line in accordance with the H start pulse (STH). However, in the method shown in FIG. 15, as described in the normal display, a pre-charge control signal (PCG) is generated immediately before the H start pulse and the pre-charge circuit writes the white display data to each data line.

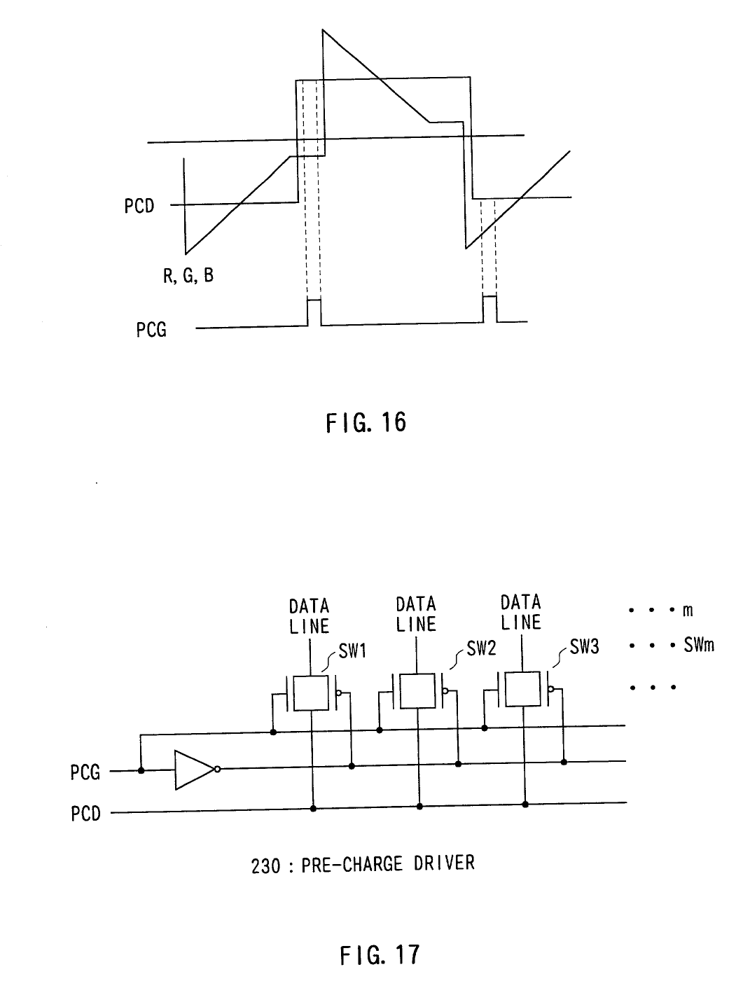

The pre-charge waveforms and the configuration of the pre-charge driver 230 installable in the LCD panel 200 will be described below referring to FIGS. 16 and 17. The pre-charge driver 230 consists of switches SW1, SW2, . . . , SWm each formed of TFT transistors which turn on in accordance with the pre-charge control signal (PCG) and the inverted version thereof. When each of the switches SW1, . . . , turns on in response to the pre-charge control signal, as shown in FIG. 16, the pre-charge data (PCD) is applied to the first to m-th data lines connected to the pre-charge data lines via the corresponding switches SW. The pre-charge data (PCD) has the polarities matched with those of R, G and B display data applied to the data lines in the 1H duration starting immediately after the outputting of the pre-charge control signal (PCG). Each voltage level is set to the intermediate voltage value between the R, G and B display data in the normal display mode.

The white display data is output to the data lines during the background display period. In the white display, the intermediate voltage level of each of the R, G and B display data are equivalent to those in the white display data. Hence, when the switches SW1 to SWm in the pre-charge driver 230 are turned on during the background display period, the pre-charge data can be supplied as the white display data to pixels associated with selected gate lines. This decreases the load to the H driver and, therefore, the power consumption thereby.

### Partial Display (Driving Methods 3 and 4

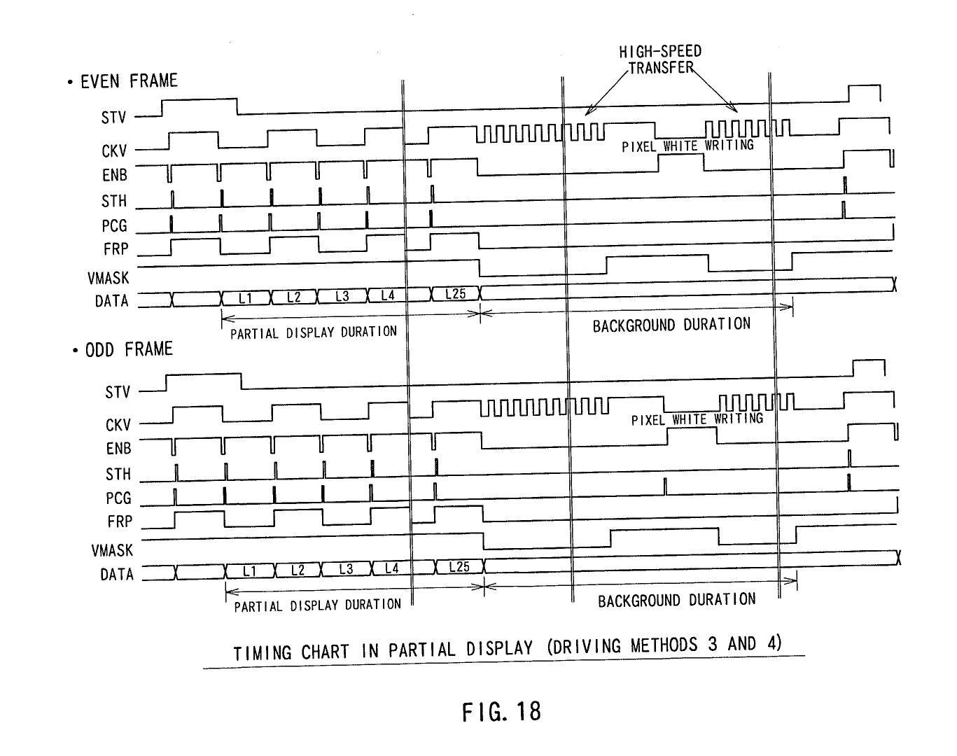

FIG. 18 specifically depicts a specific example of operational timing for the combination of the driving methods 3 and 4. The combined method differs from the method shown in FIG. 15. That is, the frequency of each timing signal in the partial display mode is low. Moreover, the gate selection signal is fast transferred within the V driver by increasing the frequency of the V clock (CKV) while the V MASK signal (VMASK) is an L level during the background display period. This driving method allows the power consumption due to the reduced drive frequency in the partial display mode and the processing load of the H driver to be decreased.

### Background Display Color

In the above-described basic configuration, the white display data (off display) is manifested on the background area after a change to the partial display mode. However, the background display data is not limited to the off display data, and other background display color data may be used to display the background display area in the color corresponding to the data. A case where the background area is displayed in a predetermined color will next be described. The display color may be, for example, red (R), green (G) or blue (B) in a color display panel.

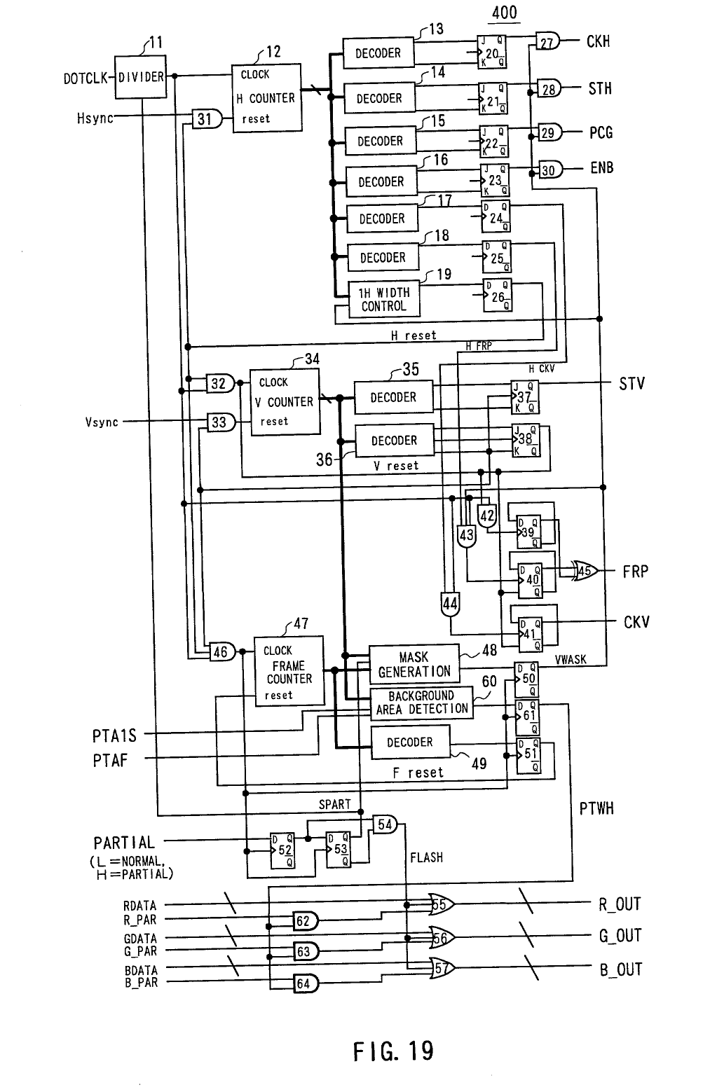

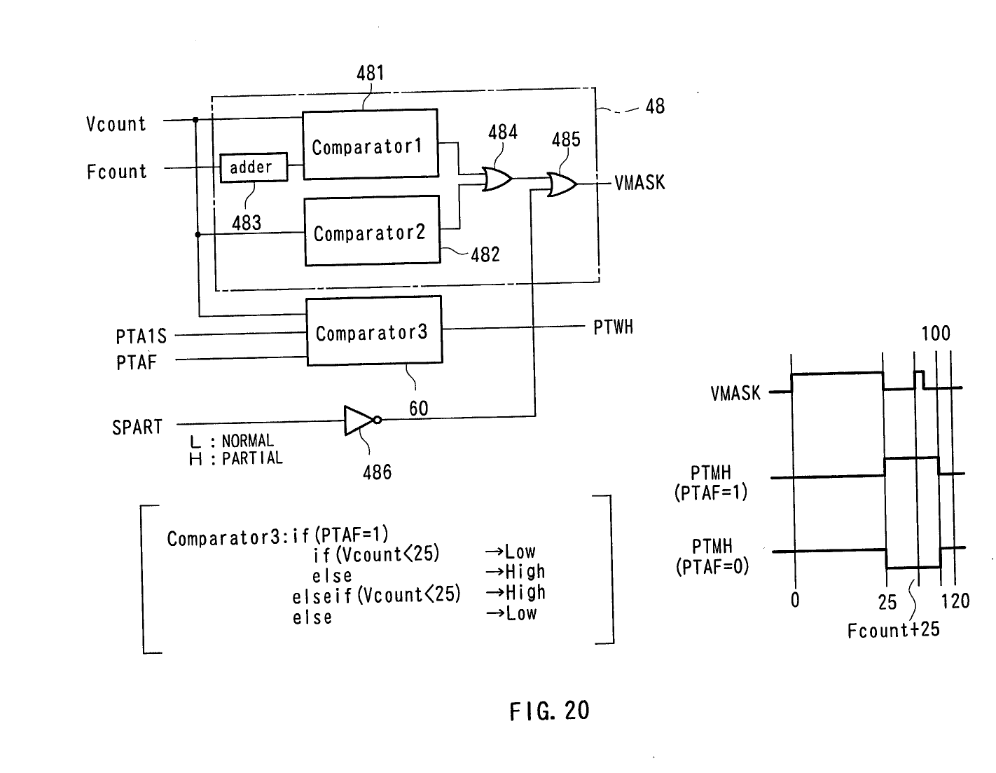

FIG. 19 shows the configuration of the timing controller 400 that displays the background area in a predetermined color except the color in the off display. FIG. 20 conceptually explains the operation of the background area detector 60. In FIG. 19, constituent elements corresponding to those in FIG. 4 are given corresponding reference numerals and hence their explanation will not be repeated here. This configuration differs from that of FIG. 4. That is, the timing controller 400 (FIG. 19) includes a configuration which detects a background area in the partial display mode and enables outputting a digital signal regarding a predetermined color during the background display period, in addition to the configuration of FIG. 4. The timing controller 400 includes a background area detector 60, a F/F 61, and AND gates 61, 62 and 63.

The background area detector 60 receives the V count value (row count value) from the V counter 34. The CPU (not shown) supplies position information (PTA1S) and position information (PTAF) to the background area detector 60 via the CPU interface 106 (FIG. 1). The position information (PTA1S) represents to the boundary of a partial display area. The position information (PTAF) represents whether or not a partial display area is above or below the boundary (e.g., H if the partial display area is above the boundary while L if the partial display area is below the boundary). The background area detector 60 produces the background area detection signal (PTWH) based on the information above. For example, if the position information PTAF is “H”, the partial display area is elevated from the boundary position (PTA1S). The background area detector 60 produces the background detection signal (PTWH) of “L” for the duration over which the V count value represents rows positioned above the boundary position (PT1S) of the partial display area. The background area detector 60 also produces the background detection signal (PTWH) of “HH” for the duration over which the V count value represents rows positioned below the boundary position (PT1S) of the partial display area. When the position information (PTAF) is “L”, the background area detector 60 produces the signal PTWH of “H” for the duration over which the V count value indicates rows positioned above the boundary position (PTA1S). Similarly, the background area detector 60 produces the signal PTWH of “L” for the duration over which the V count value indicates rows positioned above the boundary position (PTA1S).

As described above, the background area detector 60 (FIG. 19) outputs the background area detection signal (PTWH) being in an H level only for the background display duration. For example, when the background area ranges from the 25-th row to the 100-th row, as shown in FIG. 20, the background area detector 60 outputs the signal PTWH of “L” until the V count value becomes 25 and outputs the signal PTWH in an H level for the selection duration corresponding to the V count value of 25 to 100. The signal PTWH is supplied to one terminal of each of the AND gates 62, 63 and 64 respectively disposed to the R, G and B digital output lines, via the F/F 61.

The background signals (R_PAR, G_PAR, and B_PAR) set, for example, by the operator or the CPU are supplied to the other input of each of the AND gates 62, 63 and 64. When the detection signal PTWH becomes “H” in the background display duration, the background color display signals supplied to the AND gates 62, 63 and 64 are respectively output as background display data via the OR gates 55, 56 and 57.

The color white is displayed by setting all the bits (e.g. 6 bits) of the R, G and B input digital data to “H” or “1”. “blue” is represented by setting all the bits of the R and G data to “L” or “0” and setting all the bits of the B data to “H” or “1”. In this embodiment, when a single color “blue”, for example, is set as the background area color, all the bits of R_PAR and all the bits of G_PAR are set to “L” while all the bits of B_PAR are set to “H”. These bits are supplied as the display data for the background area in the partial display mode to the display panel. Thus, a single color “blue”, is displayed on the background area.

Even when the predetermined background display color is selected, it is preferable to execute the white display (off display) all over the screen in the first frame after a change to the partial display mode and then to execute the partial display and the background display in a color in the second frame. In the first frame, all the screen may be colored a given background display color, without limiting to white. For example, the display color may be the same as the background display color set in the partial display operation mode. By selecting the background color in the partial display operation for the display color of all over the screen in a changed frame, an abrupt change in the display color can be avoided in the partial display mode. Moreover, a simplified circuit can select a color other than the off display color as the display color over the entire screen in the first frame.

A configuration wherein the CPU supplies background display data corresponding to a desired color during the background period after a change to the partial display mode may be used. This configuration can display a desired color other than white for the background, without modifying the basic circuit configuration shown in FIG. 4.

Moreover, as described later, the partial display and the background display for the entire background area may be performed in the first frame, without performing the background display such as a white display over the entire screen.

An ON display color, for example, a black display in the case of a normally white display, or a desired medium tone may be freely set to the background display color described above. The off leak current of the TFT disposed for each pixel may cause slight decolorizing, that is, a change in color because of a prolonged pixel selection interval in the background area. However, according to the present invention, the background area does not aim at displaying special information. A slight color change in the background area is often maintained within an allowable range in view of the display quality. In such a case, when the background area is made of the configuration displayable in a desired color, the operator can select a desired background color.

When the off leak current of the pixel TFT transistor is sufficiently small, the background display area can be displayed in a desired ON display color or in a medium tone for a long period, without any color change. In the background area in a single color, R, G or B is displayed with the same off-display data as that for white data and the remaining colors are displayed with on-display data. Moreover, R, G or B is represented with on display data and the remaining two colors are represented with off display data. That is, in the background display in a single color such as R, G or B, at least one color is identical to “off display”. Compared with a desired medium tone, the single color is resistant to decolorizing due to the off leak current through the TFT transistor of each pixel. A change in the background display color is small in the partial display mode.

### Leading Row in Background Area

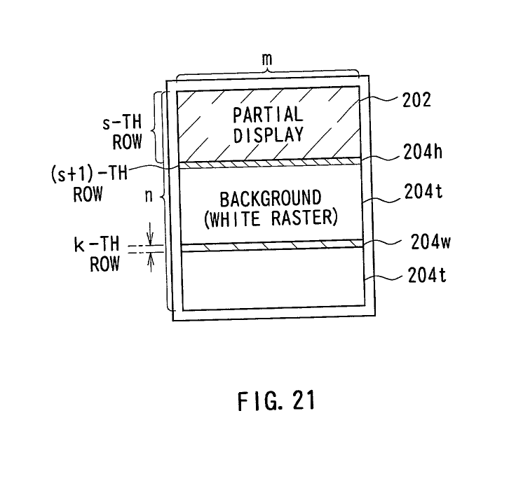

Next, the driving method for improving the quality of a background display area in the partial display mode will be described below by referring to FIG. 21. In this method, the background display such as off-display all over the screen is performed in the first frame after a change to the partial display mode. Thereafter, the status moves to the partial display mode. In the second frame following the first frame, partial display data is written into the partial display area 202 in a (s rows×m columns) matrix. The background display data is written into the leading row 204h (or (s+1)-th row) of the background area following the last row in the partial display area and in the (k rows×m columns) region 204w. That is, data is written into the leading row 204h in the background area 204 for each frame. In a manner similar to that in the above description, data is written to the (k row×m columns) matrix area 204w for each frame while the position thereof is shifted. In the (n rows×m columns) matrix, the background display data is written to respective pixels in the remaining background area, except the partial display area 202s and the (s+1)-th area 204h, once every (n−s−1)/k frames.

In this driving method, the background display data such as off-display data is certainly written to the leading row in the background area 204 following the partial display area 202, once for each frame. Therefore, this method can prevent that data written to the last row in the partial display area 202 from adversely affecting other background display area 204 selected only every plural frame periods, thus being displayed as crosstalk.

Next, the operation for writing background display data such as off-display data to the leading row 204h in the background display area will be specifically described below. In the following explanation, it is assumed that off-display data is written as background display data to the (s+1)-th area 204h being the leading row and that a single color (e.g. R, G or B) is displayed as background display data on the other background area 204 except the area 204h. In this case, displaying an arbitrary color can be dealt with by changing the setting of the MASK generator 48 and the setting of the background area detector 60 using the timing controller 400 (FIG. 19).

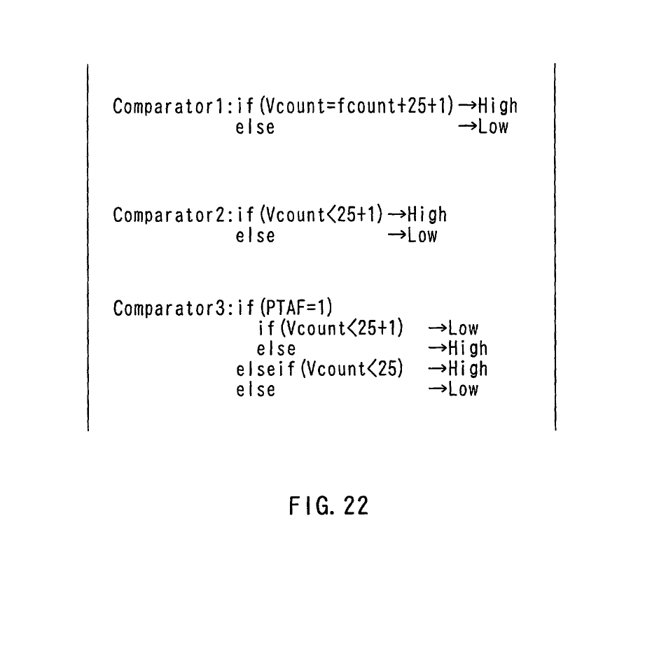

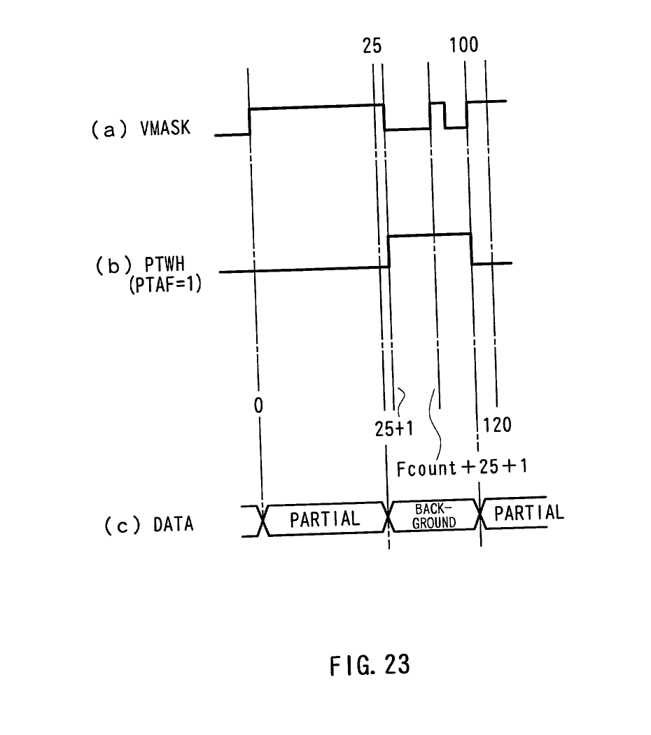

The configurations of the circuit 48 and the circuit 60 are similar to those in FIG. 20. As shown in FIG. 22, the comparator 1 (481), the comparator 2 (482) and the comparator 3 (60) are set to a changed value (refer to FIG. 20). The comparators (481) and (482) generate (a) VMASK, as shown in FIG. 23. The comparator (60) generates (b) PTWH, as shown in FIG. 23.

Specifically, when the partial display area 202 is formed of, for example, the first row to the 25-th row in an n row by m column matrix, “25+1” is set to the comparators 1 and 2. When the V count value (the number of rows) is “25+1” or more, the comparator 2 changes its output from “L” to “H”. The comparator 1 outputs “H” only when the F frame value supplied from the frame counter 47 is “25+1” and outputs “L” in other F frame values. With the SPART signal of “H” and in the partial display mode, the OR gate 485 outputs the VMASK signal as shown in FIG. 23(a). That is, the VMASK signal is in an H level for the duration between the first row and the (25+1)-th row and for the duration corresponding to the (F count value+25+1)-th row, during one frame cycle. The image selection and the display data writing are performed to the panel for the duration over which the VMASK signal is in an H level, in a manner similar to that in the normal display mode. Referring to FIG. 23, the display data changes from the partial display data to the background display data at the (25+1)-th row during the background area period. Hence, the writing to each pixel of the display data is allowed with the (25+1)-th timing. The election and writing of the background display data to the next row is performed, subsequently to the selection and writing operation of the final row in the partial display area.

Moreover, the background area detector 60 (comparator 3) is set to “25+1” as the leading value of the boundary position and is set to “100” as a final value. With the partial display area at the front of the background boundary position (PTAF=1), the background area detector 60 produces the background detection signal (PTWH) of “H” when the V count value is “25+1” or more and produces “L” when the V count value is “100” or more, as shown in FIG. 23. The PTWH signal, as shown in FIG. 19, controls to output the background color data (R_PAR, G_PAR, B_PAR) to the R, G and B lines, respectively. As shown in FIG. 23(b), because the duration other than the duration corresponding to the boundary leading row area 204h of the background duration exhibits an H level, output of the background color data is allowed.

In the duration over which the (k rows×m columns) matrix area 204w in the background area 204 is selected, arbitrary background data specified by an operator or the CPU is written to the area 204w and is displayed. The off-display data may be written to the (k rows×m columns) matrix area 204w. In this case, such an operation can be dealt with by merely setting the comparator comparison value in the MASK generator 48 (FIG. 8) to (s+1) (where s is the number (s) of partial display rows).

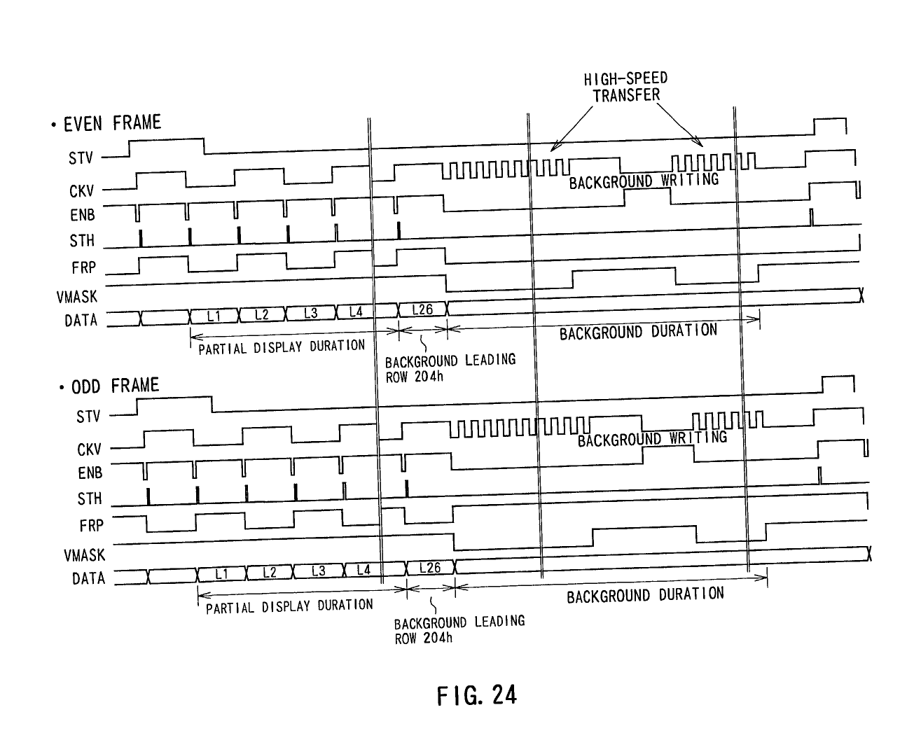

FIG. 24 shows an example of a timing chart when the driving method 4 is applied to the above-described control. In this example, an operation nearly similar to that in FIG. 14 is performed, with the significant exception that the control to the leading row 204h in the background. Referring to FIG. 24, the row clock frequency that controls the width of 1H duration is increased for a period of time corresponding to the selection duration of rows (in this example, the (n−s−1) rows), not selected in one frame, in the background area. This operation was already described for the driving method 4 and FIG. 14. The increased row clock frequency allows each row selection pulse within the V driver (FIG. 5) to be transferred at high speed. Compared with the normal operation (n row driving) mode, each row (s+1+k) can be driven with lower frequency. As a result, power consumption of the circuits in the digital processing system is reduced by an amount related to the operational frequency. Any of the driving methods 1, 2 and 3, none of which performs the fast clock transfer during a background area period not selected, may be employed with this example.

R, G or B, or a color in the color display, in addition to the off-display data (white display in the case of normally white), may be employed as the background display data to be written to the leading row area 204h. In such a case, the problem that only the leading row area 204h is seen strikingly can be avoided by using as the background display data the same data as that written to the remaining background area 204.

When plural partial display areas 202 are set in the (n rows×m columns) screen, background display data can be preferably written to the row (204h) next to the final row in each partial display area 202 for each frame. For example, when the partial display area 202 is positioned in the center or on the reverse (the lower side of the screen in FIG. 21) of the (n rows×m columns) matrix, the background display data may be written to the row previous to the leading row in the partial display area 202 every frame. Thus, the display data for the leading row of the partial display area 202 adversely affecting the background area 204 positioned ahead from the partial display area 202 can be avoided. This feature can more improve the display quality of the background area. As described above, the display quality of the background area 204 improves by writing the background display data to the rows adjacent to the partial display area 202 every frame.

### Display of First Frame Shifted to Partial Display Mode

Next, the operation and the drive circuit of implementing a partial background display, rather than a full screen background display, in the first frame in which the device is changed to the partial display mode will be described below as an example.

In the operation shown in FIG. 3, when partial display is instructed, the background display all over the screen is performed in the first frame. Then, the mode is changed to the partial display from the next (second) frame. In contrast, in the fist frame after transition, the partial display is performed on the partial display area and the background display is performed all over the background area. Thus, the partial display is smoothly changed while the whole of the screen is not instantaneously turned off in transition.

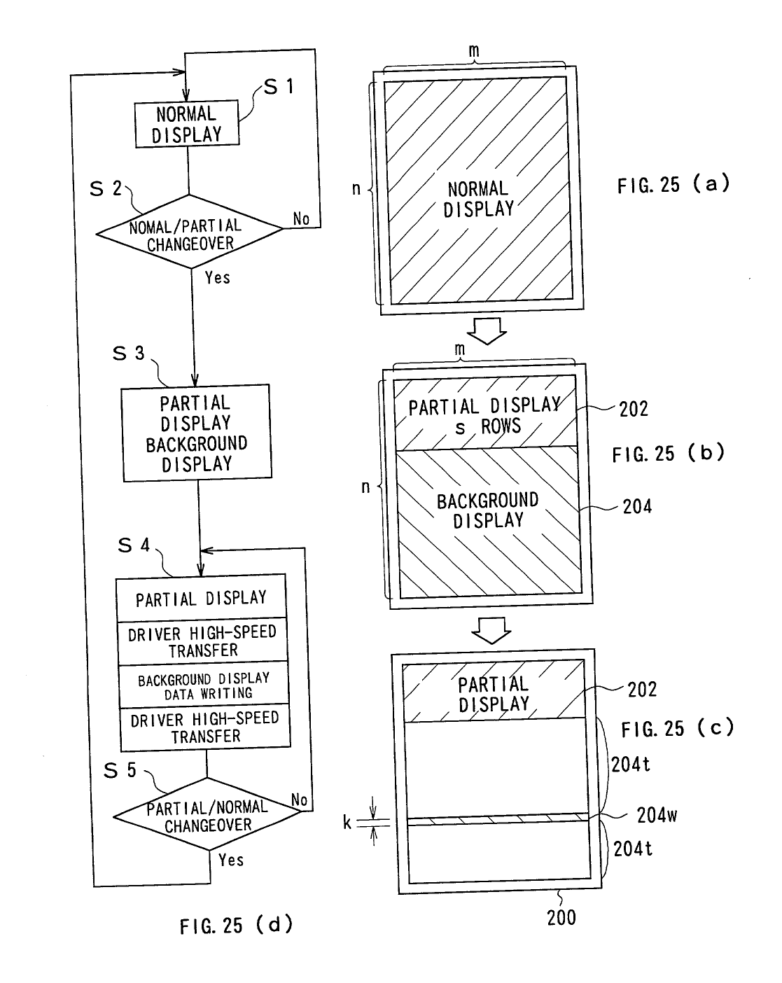

FIGS. 25(a) to 25(d) show the mode changing operation. When it is judged that the I/F circuit 106 (FIG. 1) is in a normal display mode, the LCD panel 200, as shown in FIG. 3(a), performs the normal display over the screen (S1). When the CPU transmits a partial display control instruction, the I/F circuit 106 analyzes it and then produces a partial display control signal. Thus, the status changes to the partial display mode (S2).

When the device changes to the partial display mode, the partial display data is written into the partial display area 202, as shown in FIG. 25(b). Moreover, the off-display data or the background display data such as arbitrary color data is written into the whole of the background area 204,

Display as desired can be performed on the partial display area 202, without display of a temporary background on the entire screen, immediately after the transition by performing the partial display and the background display to the whole of the background area 204 in the first frame in transition. The significant data such as the partial display data or background display data is written over the whole of the screen. Hence, this operation can prevent the display in the normal display mode from gradually changing to the background display state in the background area selected once every plural frames after the switching to the partial display.

As shown in FIG. 25(c), various partial display operations, as described above, can be employed after the second frame. That is, as shown in FIG. 25(c), the partial display area 202 in a (s rows×m columns) matrix and the (k rows×m columns) matrix area 204 are selected during one frame to perform the partial display and the background display on the corresponding areas (S4).

Some or all of the driving methods 1 to 4 can be combined for use with the method of driving the background area 204 in the partial display mode. For example, the driving method of performing the driver's high-speed transfer to non-selection rows other than the (k rows×m columns) area 204w in the background area can be employed as shown in the step S4 of FIG. 25(d). Moreover, as explained above with reference to FIG. 21, the method of selecting each frame in the background leading area 204h adjacent to the final row in the partial display area can employed in a manner similar to that in the partial display area, followed by the writing of the background display data to the selected frame.

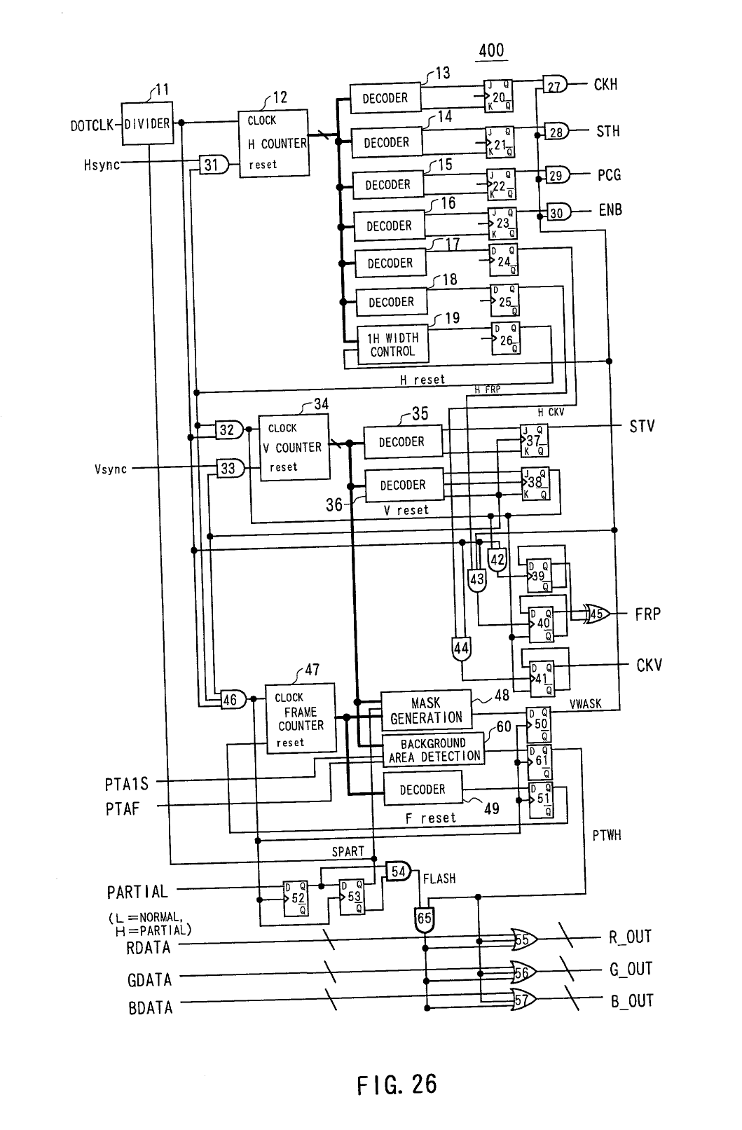

FIG. 26 depicts an example of the timing controller 400 for implementing the transition operation. In the timing controller 400, elements corresponding to those in the configuration shown in FIG. 19 are labeled with corresponding numerals and their explanation will not be repeated here. The timing controller 400 differs from that in FIG. 19 in the configuration of the digital-display-data output control section. Specifically, the timing controller 400 includes an AND gate 65 that produces a logical product of the background detection signal (PTWH) output from the background area detection circuit to the F/F 61 and the flash signal (FLASH). Each of AND gates 55, 56 and 57 has its three inputs. A corresponding R, G, or B digital signal is input to the first input. The background detection signal (PTWH) is supplied to the second input. The AND gate 65 sends its output signal to the third input.

With the above configuration, when the partial display control signal (PARTIAL) sent from the CPU via the CPU I/F circuit becomes an H level, the flash signal (FLASH), which is output via the F/Fs 52 and 53 and via the AND gate 54, becomes H level for the duration of the next frame, and then L level. The background detection signal (PTWH) becomes H level for the duration of the background display. Therefore, the AND gate 65 produces an H level for the background area in the next frame in which the partial display control signal has changed to an H level. All of the OR gates 55, 56 and 57, respectively disposed to bits of R, G and B data, produce an H level output. In this example, when all bits of the R digital output, R_OUT, the G digital output, G_OUT, and the B digital output, B_OUT, are at H level, white display (off-display) data is output. This configuration allows the off-display data to be written to the background area for the background duration in the next one frame, in which the partial display control signal has changed to an H level.

The flash signal (FLASH) returns to an L level in the second frame after a lapse of one frame from the time the partial display control signal has changed to an H level. Hence, the AND gate 65 remains its output at an L level after the second frame. Because the background detection signal (PTWH) becomes H level for the background duration, each of the AND gates 55, 56 and 57 remains its output at an H level for the background duration. Therefore, the white display data (off-display data) is supplied as display data to the data lines for each background display duration from the second frame after transition to the partial display mode.

Data displayed on the background area in the first frame and the second frame after a change to the partial display mode is not be limited only to the off-display data realized in the above-described configuration but may be R, G, or B color data or any desired color data.

The partial display after the second frame after a change to the partial display mode may be performed by the driving methods 1 to 4, or by any suitable combination of these methods. The method of selecting the background area leading row following the final row in the partial display area (or the row adjacent to the boundary of the partial display area) for each frame and writing the background display data may also be employed.

What is claimed is:

1. A method of driving a display device, said display device having a plurality of pixels in a matrix comprising n rows and m columns,
in accordance with a partial display instruction, said display device performing a desired partial display on a partial display area formed of pixels of s rows by m columns, where s is a desired value, and said display device displaying a background on a remaining background area of said matrix comprising n rows and m columns; wherein: during one frame in a partial display mode,
partial display data is written into each pixel of said s row by m column partial display area; and
background display data is written into pixels of an area of k rows by m columns in said background area;
wherein each of n, m, s, and k is an integer greater than 1 and s<n and k<n.

2. A method of driving a display device defined in claim 1, wherein row to be selected associated with pixels of said area of k rows by m columns in said background area is shifted every one frame.

3. A method of driving a display device defined in claim 2, wherein said background display data is written into each pixel in said background area over a total ((n−s)/k) frame duration.

4. A method of driving a display device defined in claim 2, wherein said background display data is written into each pixel in said background area over a total ((n−s)/k) frame duration;
polarities of said background display data are inverted with respect to a reference potential, and inverted background display data is written into pixels in the same row over a next total ((n−s)/k) frame duration.

5. A method of driving a display device defined in claim 1, wherein rows other than the k rows selected during one frame in said background display area are inhibited from being selected.

6. A method of driving a display device defined in claim 1, wherein when said partial display instruction is issued,
a pixel clock is used as a unit clock, a frequency of said pixel clock being lower than that of a pixel clock used as a unit clock for selecting and normally displaying all pixels of said matrix comprising n rows and m columns during one frame;
said partial display data is written into all pixels in said partial display area; and
said background display data is written into pixels of said area of k rows by m columns in said background display area.

7. A method of driving a display device defined in claim 6, wherein
a transfer rate of a row selection pulse is increased, when said partial display instruction is issued, and arrival of a selection duration of rows other than those of said area of k rows by m columns in said background display area is detected.

8. A method of driving a display device defined in claim 1, wherein
said background display data is written to all pixels of said matrix comprising n rows and m columns after said partial display instruction has been issued;
said partial display data is sequentially written into pixels of said area of s rows by m columns, and background display data is written into pixels of said area of k rows by m columns.

9. A method of driving a display device defined in claim 1, wherein said background display data comprises off-display data or arbitrary background color data.

10. A method of driving a display device defined in claim 1, wherein said display device comprises a liquid crystal device.

11. A method of driving a display device, said display device having a plurality of pixels in a matrix comprising n rows and m columns,
in accordance with a partial display instruction, said display device performing a partial display on a partial display area formed of an s row by m column matrix, where s is a desired value, and said display device displaying a background on a remaining background area; wherein
during one frame in a partial display mode, predetermined partial display data is sequentially written into each pixel of said partial display area; and
background display data is written into pixels of the (s+1)-th row area next to the final row in said partial display area and into pixels of an area of k rows by m columns, within said background area;
where each of n, m, s, and k is an integer greater than 1 and s<n and k<n−s−1.

12. A method of driving a display device defined in claim 11, wherein row to be selected associated with pixels of said area of k rows by m columns in said background area is shifted every one frame.

13. A method of driving a display device defined in claim 12, wherein said background display data is written into pixels of an area of (n−s−1) rows by m columns in said background display area over a total ((n−s−1)/k) frame duration.

14. A method of driving a display device defined in claim 12, wherein
said background display data is written into pixels of said area of (n−s−1) rows by m columns in said background display area over a total ((n−s−1)/k) frame duration;
polarities of said background display data are inverted with respect to a reference potential, and inverted background display data is written into pixels in the same row in a next total ((n−s−1)/k) frame duration.

15. A method of driving a display device defined in claim 11, wherein
when said partial display instruction is issued,
a pixel clock is used as a unit clock, a frequency of said pixel clock being lower than that of a pixel clock used as a unit clock for selecting and normally displaying all pixels of said matrix comprising n rows and m columns during one frame;
said partial display data is written into all pixels in said partial display area; and
said background display data is written into pixels of said (s+1)-th row area and pixels of said area of k rows by m columns, in said background display data.

16. A method of driving a display device defined in claim 11, wherein
said background display data is written into all pixels of said matrix comprising n rows and m columns after said partial display instruction has been issued;
said partial display data is sequentially written into pixels of said area of s rows by m columns; and background display data is written into pixels of said (s+1)-th pixel and pixels of said area of k rows by m columns.

17. A method of driving a display device defined in claim 11, wherein
during the next first frame when said partial display instruction is detected,
said partial display data is sequentially written into each pixel in said partial display area formed of said s row by m column matrix, and said background display data is sequentially written into all pixels of said background area;
during each frame after a second frame following said first frame,
said partial display data is written into each pixel in said partial display area formed of said s row by m column; and said background display data is written into pixels of the (s+1)-th row area and pixels of said area of k rows by m columns in said background area.

18. A method of driving a display device defined in claim 11, wherein said background display data comprises off-display data or arbitrary background color data.

19. A method of driving a display device defined in claim 11, wherein said display device comprises a liquid crystal device.

20. A method of driving a display device, said display device having a plurality of pixels in a matrix comprising n rows and m columns,
in accordance with a partial display instruction, said display device performing a desired partial display on a partial display area formed of pixels of area of s rows by m columns, where s is a desired value, and said display device displaying a background on a remaining background area of said matrix comprising n rows and m columns; wherein:
during a first frame over which said partial display instruction is detected and a normal display mode changes to a partial display mode,
predetermined partial display data is sequentially written into each pixel of said partial display area of s rows by m columns; and background display data is sequentially written into pixels of said background area;
during each frame after the second frame following the first frame in a partial display mode, said partial display data is written into each pixel of said area of s rows by m columns partial display area; and
said background display data is written into pixels of said area of k rows by m columns in said background area;
wherein each of n, m, s, and k is an integer more than 1 and s<n and k<n−s.

21. A method of driving a display device defined in claim 20, wherein row to be selected associated with pixels of said area of k row by m columns in said background area is shifted every one frame.

22. A method of driving a display device defined in claim 21, wherein said background display data is written into all pixels in said background area over a total (n−s)/k frame duration after said second frame.

23. A method of driving a display device defined in claim 21, wherein rows other than the k row in said background area selected during one frame after the second frame are inhibited from being selected.

24. A method of driving a display device defined in claim 20, wherein:
during each frame after the second frame,
a pixel clock is used as a unit clock, a frequency of said pixel clock being lower than that of a pixel clock used as a unit clock for selecting and normally displaying all pixels of said matrix comprising n rows and m columns during one frame;
said partial display data is written into all pixels in said partial display area; and
said background display data is written into pixels of said area of k rows by m columns in said background display area.

25. A method of driving a display device defined in claim 20, wherein said background display data comprises off-display data or arbitrary background color data.

26. A method of driving a display device defined in claim 20, wherein said display device comprises a liquid crystal device.

27. A drive circuit for a display device, said display device having a plurality of pixels in a matrix comprising n rows and m columns, and said plurality of pixels are selected every row line and display display data supplied from a column line,
when a partial display instruction is issued, during one frame, said display device selects pixels in an area of s rows by m columns in said matrix comprising n rows and m columns, sequentially writes predetermined partial display data, selects pixels in an area of k rows by m columns in a remaining background area in said matrix comprising n rows and m columns, and writes background display data, said drive circuit comprising:
a row clock generator for generating a row clock corresponding to a row selection duration of each row;
a row clock counter for counting a row clock every one frame;
a partial display row detector for detecting an incoming timing for s rows to which said partial display data is written;
a background display row detector for detecting an incoming timing for a k row to which background display data is written during said one frame; and
a driver control signal generator for producing a driver control signal when said partial display row detector or said background display row detector detects an arrival of a row to be displayed, said driver control signal allowing a row driver driving said matrix comprising n row and m columns every row to perform a row drive operation;
wherein each of n, m, s and k is an integer greater than 1 and s<n and k<n.

28. A drive circuit for a display device defined in claim 27, further comprising a frame counter for counting the number of frames, and wherein said background display row detector shifts row to which said background display data is written based on a count value counted by said frame counter.

29. A drive circuit for a display device defined in claim 27, further comprising a polarity inverted signal generator for inverting a polarity of display data with respect to a predetermined reference voltage every unit duration; and wherein respective pixels in said background display area are respectively selected once over one background display duration being a total (n−s)/k frame duration, and said polarity inverted signal generator detects an arrival of the next one background duration and inverts the polarity of said background display data.

30. A drive circuit for a display device defined in claim 27, further comprising a frequency divider for dividing unit clocks used for selecting and normally displaying all pixels of said matrix comprising n rows by m columns; wherein
when said partial display instruction is issued, during one frame,
using as a unit clock divided pixel clocks from said frequency divider, said partial display data is controlled to write to pixels of said area of s rows by m columns and said background display data is controlled to write to pixels of said area of k rows by m columns.

31. A drive circuit for a display device defined in claim 30, further comprising a row clock controller for detecting, based on a display row detection signal in said partial display row detector and said background row detector, an arrival of a selection duration of rows other than pixels of said area of k rows by m columns, and increasing the frequency of said row clock.

32. A drive circuit for a display device defined in claim 27, further comprising a mode changeover timing controller for, when an instruction for changing form a normal display mode to a partial display mode is issued, changing display data to all pixels of said matrix comprising n row by m columns to background display data in the next first frame of said instruction and starting said driver control signal generator to generate said driver control signal, from the next frame.

33. A method of driving a display device defined in claim 27, wherein said background display data comprises off-display data or arbitrary background color data.

34. A method of driving a display device defined in claim 27, wherein said display device comprises a liquid crystal device.

35. A drive circuit for a display device, said display device having a plurality of pixels in a matrix comprising n rows and m columns, and said plurality of pixels are selected every row line and display display data supplied from a column line,
when a partial display instruction is issued, during one frame,
said display device selects pixels in an area of s rows by m columns in said matrix comprising n rows and m columns, sequentially writes predetermined partial display data, selects pixels of (s+1)-th row and pixels of an area of k rows by m columns in the remaining background area within said matrix comprising n rows and m columns, and writes background display data, comprising:
a row clock generator for generating a row clock corresponding to a row selection duration of each row;
a row clock counter for counting a row clock every one frame;
a partial display row detector for detecting an incoming timing for s rows to which said partial display data is written;
a background display row detector for detecting an incoming timing for the (s+1)-th row and k row to which background display data is written during said one frame; and a driver control signal generator for producing a driver control signal when said partial display row detector or said background display row detector detects an arrival of a row to be displayed, said driver control signal allowing a row driver driving said a matrix comprising n rows and m columns every row to perform a row drive operation,
wherein each of n, m, s, and k is an integer more than 1 and s<n and k<n−s-1.

36. A drive circuit for a display device defined in claim 35, further comprising a frame counter for counting the number of frames, and wherein
said background display row detector shifts row to which said background display data is written based on a count value counted by said frame counter.

37. A drive circuit for a display device defined in claim 35, further comprising a polarity inverted signal generator for inverting a polarity of display data with respect to a predetermined reference voltage every unit duration, and wherein
respective pixels in said background display area, except pixels associated with said (s+1)-th row, are respectively selected once over one background display duration being a total (n−s−1)/k frame duration, and said polarity inverted signal generator detects an arrival of the next one background duration and inverts the polarity of said background display data.

38. A drive circuit for a display device defined in claim 35, further comprising a frequency divider for dividing unit clocks used for selecting and normally displaying all pixels of said matrix comprising n rows and m columns during one frame; wherein
when said partial display instruction is issued, during one frame,
using as a unit clock divided pixel clocks from said frequency divider, said partial display data is controlled to write to pixels of said area of s rows by m columns and said background display data is controlled to write to pixels of (s+1)-th row and said area of k rows by m columns.

39. A drive circuit for a display device defined in claim 38, further comprising a row clock controller for detecting, based on a display row detection signal in said partial display row detector and said background row detector, an arrival of a selection duration of rows other than pixels associated with the (s+1)-th row and pixels of said area of k rows by m columns, and increasing the frequency of said row clock.

40. A method of driving a display device defined in claim 35, wherein said background display data comprises off-display data or arbitrary background color data.

41. A method of driving a display device defined in claim 35, wherein said display device comprises a liquid crystal device.

42. A drive circuit for a display device, wherein said display device having a plurality of pixels in a matrix comprising n rows and m columns, and said plurality of pixels are selected every row line and display display data supplied from a column line,
when a partial display instruction is issued, during one frame,
said display device selects pixels in an area of s rows by m columns in said matrix comprising n rows and m columns, sequentially writes predetermined partial display data, selects pixels from an area of k rows and m columns in the remaining background area within said matrix comprising n rows and m columns, and writes background display data, comprising:
a row clock generator for generating a row clock corresponding to a row selection duration of each row;
a row clock counter for counting a row clock every one frame;
a partial display row detector for detecting an incoming timing for s rows to which said partial display data is written;
a background area detector for detecting an incoming timing for the leading row and the final row of said background area;
a background display row detector for detecting an incoming timing for k rows to which background display data is written during one frame in a partial display mode;
a data output controller for allowing partial display data to be output for the duration over said partial display row detector detects an arrival of a row to be displayed and for setting output display data to background display data for the duration over which said background area detector detects an arrival of the leading row and the final row in said background area, in the first frame in transition from a normal display mode to a partial display mode; and
a driver control signal generator for producing a driver control signal when said partial display row detector or said background display row detector detects an arrival of a row to be displayed after a second frame in transition to a partial display mode, said driver control signal allowing a row driver to perform a row drive operation, wherein each of n, m, s, and k is an integer more than 1 and s<n and k<n−s.

43. A drive circuit for a display device defined in claim 42, wherein said background display data comprises off-display data or arbitrary background color data.

44. A drive circuit for a display device defined in claim 42, wherein said display device comprises a liquid crystal device.
